(19) United States
(12) Patent Application Publication
(10) Pub. No.: US 2025/0095636 A1
(43) Pub. Date: Mar. 20, 2025

(54) SYSTEM AND METHOD FOR IMPROVING AN END-TO-END AUTOMATIC SPEECH RECOGNITION MODEL

(71) Applicant: Oracle International Corporation, Redwood Shores, CA (US)

(72) Inventors: Duy Vu, Melbourne (AU); Yu-Heng Hong, Carlton (AU); Ying Xu, Albion (AU); Philip Arthur, Sydney (AU)

(73) Assignee: Oracle International Corporation, Redwood Shores, CA (US)

(21) Appl. No.: 18/823,371

(22) Filed: Sep. 3, 2024

Related U.S. Application Data
(60) Provisional application No. 63/583,227, filed on Sep. 15, 2023.
(60) Provisional application No. 63/583,214, filed on Sep. 15, 2023.

(51) Int. Cl. G10L 15/06; G10L 13/08; G10L 15/26

(52) U.S. Cl. CPC G10L 15/063; G10L 13/08; G10L 15/26

(57) ABSTRACT

Techniques are disclosed herein for improving the performance of an end-to-end (E2E) Automatic Speech Recognition (ASR) model in a target domain. A set of test examples are generated. The set of test examples comprise multiple subsets of test examples and each subset of test examples corresponds to a particular test category. A machine language model is then used to convert audio samples of the subset of test examples to text transcripts. A word error rate is determined for the subset of test examples. A test category is then selected based on the word error rates and a set of training examples is generated for training the ASR model in a particular target domain from a selected subset of test examples The training examples are used to fine-tune the model in the target domain. The trained model is then deployed in a cloud infrastructure of a cloud service provider.

### CROSS-REFERENCE TO RELATED APPLICATIONS

The present application claims the benefit of and priority to U.S. Provisional Application No. 63/583,227, filed Sep. 15, 2023, and to U.S. Provisional Application No. 63/583,214, filed Sep. 15, 2023, the entire contents of which are incorporated herein by reference for all purposes.

### BACKGROUND

Clinical environments such as healthcare facilities often include different healthcare providers working together and communicating with one another to treat patients. Documenting patient encounters, capturing information conveyed during those encounters and/or pertaining to events occurring before and/or after the encounters, populating patient records such as electronic health records, and healthcare practice management are integral parts of the practice of many healthcare providers and important to ensuring high-quality healthcare. Traditional means for performing tasks associated with providing healthcare often involve several different devices such as listening devices, portable electronic devices, workstations, and the like, and end-users who are equipped with the training, knowledge, experience, and skills to properly utilize these devices and participate in the healthcare process. Relying on different devices and qualified end-users to perform clinical tasks is cumbersome, time and resource intensive, costly, and reduces efficiencies, which may lead to lower-quality healthcare.

In certain approaches, Artificial Intelligence (AI)-based tools have been used in healthcare settings to facilitate care and management of patient populations. For instance, in a healthcare setting, an AI based tool that uses Automatic Speech Recognition (ASR) technology can be used to obtain information relevant to patients faster using a conversational experience (e.g., using one or more voice interfaces). Automatic Speech Recognition (ASR) refers to a technology that enables humans to communicate with a computer interface using their voice in a manner similar to actual human conversations. ASR voice technologies generally begin by employing an acoustic model that changes sound waves into binary code. Then, language and pronunciation models are used to form words and sentences from each sound in context and sequence. Recent advances in ASR voice technology take a new approach to this process by utilizing an end-to-end (E2E) neural network model rather than relying on multiple models to perform speech recognition. An E2E ASR system simplifies the speech recognition process by converting speech into words much faster and with a simpler architecture than conventional ASR systems. An E2E ASR system can directly map an audio input into its corresponding text output thereby eliminating the need for intermediate representations that are typically required by conventional ASR systems.

E2E ASR models have achieved significant accuracy and robustness in general speech domains where these models are generally trained using very large speech datasets. However, these models do not generally perform as expected in a target domain environment. It is a non-trivial and challenging task to build an E2E ASR model for a target environment because these models require specific knowledge in certain fields (target environments) and the application of certain techniques that may be relevant to the target environment. Thus, there is a need for developing techniques that facilitate building models for a target domain more efficiently than what is possible by existing implementations.

### BRIEF SUMMARY

Techniques are disclosed herein for improving the performance of an end-to-end (E2E) Automatic Speech Recognition (ASR) model in a target domain. In certain embodiments, techniques are disclosed for generating training datasets to be used for training an E2E ASR model in a target domain, fine-tuning the model based on the training datasets, and deploying the trained model in a cloud infrastructure of a cloud service provider.

In some embodiments, a method includes generating a set of test examples. The set of test examples includes multiple subsets of test examples. Each respective subset of test examples of the subsets of test examples corresponds to a particular test category of a plurality of test categories. For each respective subset of test examples of the subsets of test examples, a machine language model is used to convert audio samples of the respective subset of test examples to text transcripts. For each respective subset of test examples, a word error rate is determined for the respective subset of test examples by comparing the text transcripts to text samples corresponding to the audio samples of the respective subset of test examples. In certain examples, the word error rate for the respective subset of test examples is included in a set of word error rates for the set of test examples. A test category from multiple test categories is then selected based on the word error rates for the set of test examples and a set of training examples is generated from a selected subset of test examples of the subsets of test examples, where the selected subset of test examples corresponding to the test category.

In some embodiments, the method includes generating the set of examples by accessing a set of terms and using a pre-trained language model to generate a set of sentences for the set of terms. The method then includes extracting a subset of sentences from the set of sentences where each sentence of the subset of sentences comprises a term in the set of terms. The method includes processing the subset of sentences to generate a set of processed sentences. The processed sentences are generated by normalizing text in the subset of sentences and phonetically transcribing the text in the subset of sentences. A text-to-speech model is then used to generate multiple audio samples for each respective processed sentence of the set of processed sentences and the set of test examples are formed based on the multiple audio samples and the subset of sentences.

In some embodiments, the set of test examples are generated by accessing a template. The template comprises a set of named entity classes and lists of values for the set of named entity classes. The set of test examples are then formed by (i) selecting a respective named entity class of the set of named entity classes, (ii) selecting a value from a list of values of the lists of values, the list of values corresponding to the respective named entity class, (iii) populating a portion of the template corresponding to the respective named entity class, repeating steps (i)-(iii) for each respective named entity class of the set of named entity classes and repeating steps (i)-(iv) a predetermined number of times.

In some embodiments, the word error rate for the respective subset of test examples is determined by comparing a text transcript for a respective test example of the respective subset of test examples to a text sample corresponding to an audio sample for the respective test example. The text sample is included in the text samples and the audio sample being is included in the audio samples.

In some embodiments, the test category is selected by identifying a candidate word error rate in the set of word error rates that is the greatest among word error rates in the set of word error rates, identifying a candidate subset of test examples of the set of test examples that is associated with the candidate word error rate, and identifying a candidate test category that is associated with the candidate subset of test examples. The candidate test category is included in the multiple test categories.

In some embodiments, the set of training examples are generated from the selected subset of test examples by applying a data augmentation technique to the selected subset of test examples. In some examples, a total speech time that is associated with the set of training examples is greater than a total speech time associated with the selected subset of test examples.

In some embodiments, the set of training examples is a set of first training examples, where the set of first training examples comprises a first subset of first training examples and a second subset of first training examples. The method includes accessing a set of second training examples, the set of second training examples comprising a third subset of second training examples and a fourth subset of second training examples, assigning sampling weights to the first subset of first training examples, the second subset of first training examples, the third subset of second training examples, and the fourth subset of second training examples, sampling a set of candidate training examples from the first subset of first training examples, the second subset of first training examples, the third subset of second training examples, and the fourth subset of second training examples based on the sampling weights, generating an updated machine learning model by fine-tuning the machine learning model using the set of candidate training examples and deploying the updated machine learning model to a cloud infrastructure of a cloud service provider.

In some embodiments, the method includes using a hyperparameter tuning process to identify the sampling weights prior to assigning sampling weights to the first subset of first training examples, the second subset of first training examples, the third subset of second training examples, and the fourth subset of second training examples.

In some embodiments, the method includes accessing an audio recording, providing the audio recording to the updated machine learning model, using the updated machine learning model to convert the audio recording to a transcript for the audio recording and storing the transcript in a storage medium of the cloud infrastructure.

Some embodiments include a system that includes one or more processing systems and one or more computer-readable media storing instructions which, when executed by the one or more processing systems, cause the system to perform part or all of the operations and/or methods disclosed herein.

Some embodiments include one or more non-transitory computer-readable media storing instructions which, when executed by one or more processing systems, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Features, embodiments, and advantages of the present disclosure are better understood when the following Detailed Description is read with reference to the accompanying drawings.

FIG. 1 is an example of a healthcare environment that includes capabilities for providing various services to healthcare providers to facilitate care and management of their patient populations, according to certain embodiments.

FIG. 2 is a simplified block diagram of an environment incorporating an automatic speech recognition system and a model improvement system, according to certain embodiments.

FIG. 3 is a process flow for generating a set of training examples for incrementally fine-tuning an Automatic Speech Recognition (ASR) model, according to certain embodiments.

FIG. 4 is a simplified block diagram of the various subsystems and the interaction between the subsystems of the test example generation subsystem shown in FIG. 2, according to certain embodiments.

FIG. 5 describes a process flow for generating a set of test examples by processing a set of sentences, where the set of sentences is obtained using a pre-trained language model and a set of terms, according to certain embodiments.

FIG. 6 describes a process flow for constructing a set of sentences based on a template, according to certain embodiments.

FIG. 7 is a simplified block diagram of the various subsystems of the test example evaluation subsystem 216 and the interaction between the subsystems, according to certain embodiments.

FIG. 8 describes a process flow for evaluating a set of test examples, according to certain embodiments.

FIG. 9 is a simplified block diagram of the various subsystems and the interaction between the subsystems of the training examples generation and model fine-tuning subsystem shown in FIG. 2, according to certain embodiments.

FIG. 10 describes a process flow for generating a set of training examples for training an automatic speech recognition (ASR) model in a target domain, according to certain embodiments.

FIG. 11 describes a process flow for fine-tuning an automatic speech recognition (ASR) model based on a set of training examples, according to certain embodiments.

FIG. 12 depicts a table that illustrates a set of sampling weights that can be assigned to the various groups and subgroups of training datasets created using a combination of general domain datasets and target domain datasets, according to certain embodiments.

FIG. 13 is a block diagram illustrating one pattern for implementing a cloud infrastructure as a service system according to certain embodiments.

FIG. 14 is a block diagram illustrating another pattern for implementing a cloud infrastructure as a service system according to certain embodiments.

FIG. 15 is a block diagram illustrating another pattern for implementing a cloud infrastructure as a service system according to certain embodiments.

FIG. 16 is a block diagram illustrating another pattern for implementing a cloud infrastructure as a service system according to certain embodiments.

FIG. 17 is a block diagram illustrating an example computer system according to certain embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

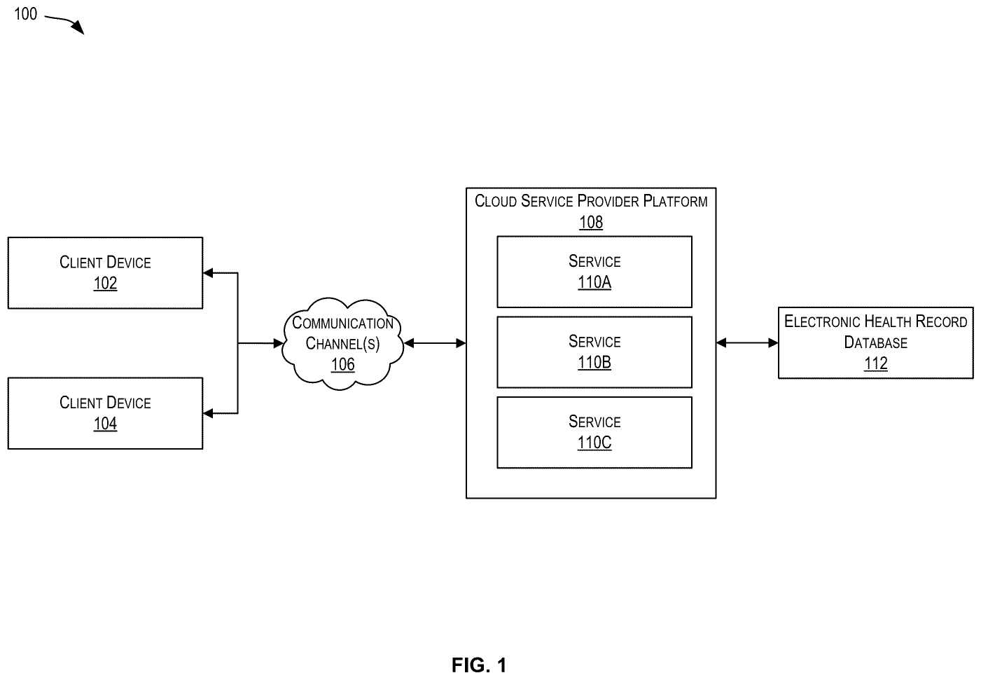

FIG. 1 is an example of a healthcare environment 100 that includes capabilities for providing various services to healthcare providers to facilitate care and management of their patient populations, according to certain embodiments. The term healthcare provider generally refers to healthcare practitioners and professionals including, but not limited to: physicians (e.g., general practitioners, specialists, surgeons, etc.); nurse professionals (e.g., nurse practitioners, physician assistants, nursing staff, registered nurses, licensed practical nurses, etc.); other professionals (e.g., pharmacists, therapists, technicians, technologists, pathologists, dietitians, nutritionists, emergency medical technicians, psychiatrists, psychologists, counselors, dentists, orthodontists, hygienists, etc.).

The healthcare environment 100 includes a cloud service provider platform 108 that includes capabilities for providing various services to subscribers (e.g., end-users) of the cloud service provider platform 108. The end-users (e.g., clinicians such as doctors and nurses) may utilize the various services provided by the cloud service provider platform 108 to perform various functions involving the treatment, care, observation, and so on of patients. For instance, in the healthcare environment 100, the end-users can utilize the functionality provided by the services to view, edit, or manage a patient's electronic health record, perform administrative tasks such as scheduling appointments, manage patient populations, provide customer service to facilitate operation of the healthcare environment 100 and so on.

The services provided by the cloud service provider platform 108 may include, but are not limited to, digital assistant services, authentication services, user management services, frontend services (e.g., entry point (façade) to all services), and other management services. The various services may be implemented on one or more servers of the cloud service provider platform 108 and may be provided to end-users who subscribe to the cloud services provided by the platform 108. In a certain implementation, the services provided by the cloud service provider platform 108 may represent digital assistant services that may be provided to healthcare providers such as doctors, nurses, technicians, clinicians, medical personnel, and the like. A digital assistant service can be configured to serve as an artificial intelligence-driven (AI-driven) conversational-type interface for the platform 108 that can conduct conversations with end users (e.g., those using the client devices 102, 104) and perform functions and/or tasks based on the information conveyed by and/or ascertained from those conversations and other sources. The digital assistant service can be configured with and/or configured to access natural language understanding (NLU) capabilities such as natural language processing, named entity recognition, intent classification, and so on. In some implementations, the digital assistant service can be skill-driven in which the digital assistant service includes bots that each include one or more skills for conducting conversations and performing functions and/or tasks. In some implementations, the digital assistant service can be LLM-based and agent-driven in which agent(s) coordinate with LLM(s) for conducting conversations and performing functions and/or tasks. Examples of skill-driven and LLM-based and agent-driven digital assistants are described in U.S. patent application Ser. No. 17/648,376, filed on Jan. 19, 2022, and U.S. patent application Ser. No. 18/624,472, filed on Apr. 2, 2024, each of which are incorporated by reference as if fully set forth herein.”

By way of example, the service 110A may represent an ambient service, which is an AI-powered, voice-enabled service that automatically documents patient encounters accurately and efficiently at the point of care and provides quick action suggestions, the service 110B may represent a dictation service 110B that allows doctors to generate medical records from voice (e.g., using a Large Language Model (LLM) or pre-seeded templates), the service 110C may represent a speech service which is an AI service that applies Automatic Speech Recognition (ASR) technology to transform audio-based content into text and so on. Using ASR technology, humans can communicate with a computer interface using their voice in a manner similar to actual human conversations.

Various end-users may interact with the cloud service provider platform 108 using one or more client devices (e.g., 102, 104) that may be communicatively coupled to one or more servers implemented by the services (e.g., 110A, 110B, 110C), via one or more communication channels 106. The client devices (102, 104) may be of various types, including but not limited to, a mobile phone, a tablet, a desktop computer, and the like. The users can interact with the various services via a user interface (UI) of an application installed on the client devices (102, 104) to obtain information about a patient such as medical information from an electronic health record for the patient stored in the electronic health record database 210, collect information relevant to the observation, care, treatment, and/or management of a patient, and so on.

In certain embodiments, the end-users may utilize the functionality provided by services (110A, 110B and 110C) using a conversational experience. For instance, the users may use one or more voice interfaces provided by an application installed on the client device to interact with the services. The users can interact with the application based on touch input (e.g., tapping, swiping, pinching) and voice input captured by the client device to obtain information about a patient. Voice interactions can be initiated via a wake word or by tapping a dedicated button on screen. The application can interface with the various services which can generate conversational-type responses to the voice-based interactions. In some implementations, the responses can be natural language responses and/or graphical responses. For instance, a user may utilize the functionality provided by the speech service (110C) to perform various tasks via natural language-based conversations. As part of a conversation, a user may provide a user input such as an audio input (e.g., when a user says or speaks something) to the speech service 110C. The speech service 110C may include capabilities to convert the audio input into a text transcript using various speech-to-text processing techniques. For example, the speech service 110C can make use of Automatic Speech Recognition (ASR) to convert the audio input into a text transcript. The speech service 110C may then process the text transcript by applying natural language understanding (NLU) techniques to understand the meaning of the user (audio) input and provide a response to the user.

The healthcare environment 100 additionally includes an electronic health record database 112. The database 112 may be a storage device managed by a healthcare provider and/or stored remotely such as in a cloud-based server or remote database managed by the cloud service provider platform 108. The database 112 may be configured to store electronic health information related to patients. Each electronic health record associated with a patient can be linked to other electronic health records associated with the patient. For example, one healthcare provider such as a family physician may generate an electronic health record for a patient and store that electronic health record in a local database and another healthcare provider such as a hospital may generate an electronic health record for the patient and store that electronic health record in a cloud-based databased. The two electronic health records for the patient can be linked to the patient using an identifier for the patient such as a portion of the patient's personally identifiable information.

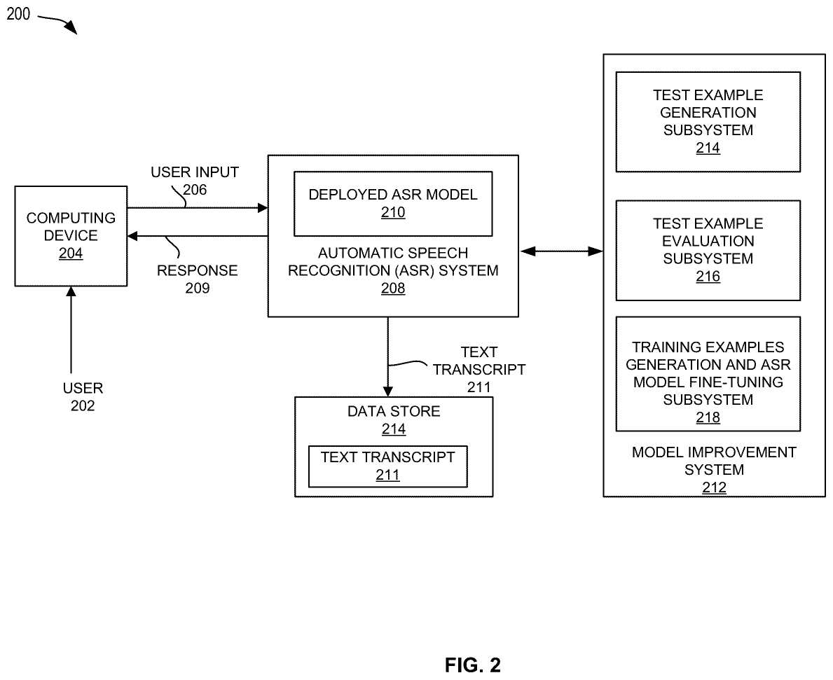

The healthcare environment 100 depicted in FIG. 1 is merely an example and is not intended to unduly limit the scope of claimed embodiments. One of ordinary skill in the art would recognize many possible variations, alternatives, and modifications. For example, in some implementations, the healthcare environment 100 can be implemented using more or fewer services than those shown in FIG. 1, may combine two or more services, or may have a different configuration or arrangement of services. For example, in certain embodiments, the speech service 110C may implement an Automatic Speech Recognition (ASR) model 210 (e.g., a machine learning model) that applies ASR technology to convert the audio input into a text transcript. The speech service 110C may be additionally configured to communicate with another service that may be responsible for generating and selecting sets of training data for training the ASR model. In certain embodiments, and as described in detail in FIGS. 2-12 below, the speech service 110C may be configured with capabilities to communicate with a model improvement system that is configured to generate training datasets for training an Automatic Speech Recognition (ASR) model in a particular target domain. Additionally, techniques are disclosed for fine-tuning the ASR model based on the datasets and deploying the trained model in a cloud infrastructure of a cloud service provider.

As previously described, Automatic Speech Recognition (ASR) refers to a technology that enables humans to communicate with a computer interface using their voice in a manner similar to actual human conversations. For example, using ASR technology, clinicians can obtain information relevant to their patients faster using a conversational experience (e.g., using one or more voice interfaces). ASR voice technologies generally begin by employing an acoustic model that changes sound waves into binary code. Then, language and pronunciation models are used to form words and sentences from each sound in context and sequence. Recent advances in ASR voice technology take a new approach to this process by utilizing an end-to-end (E2E) neural network model rather than relying on multiple models to perform speech recognition. An E2E ASR system simplifies the speech recognition process by converting speech into words much faster and with a simpler architecture than conventional ASR systems. An E2E ASR system can directly map an audio input into its corresponding text output thereby eliminating the need for intermediate representations that are typically required by conventional ASR systems.

E2E ASR models (referred to throughout this disclosure simply as ASR models) have achieved significant accuracy and robustness in general speech domains where these models have been trained using very large speech datasets. However, these models do not generally perform as expected in a target domain environment. The performance of these models is lower than expected in a target environment due to a variety of reasons. For example, an ASR model that is pre-trained on generic datasets may fail to recognize certain terms due to the low coverage of lexicons in speech and test training data in the target domain. Additionally, due to differences in domain language usage, words from different domains can be pronounced in a similar manner but have distinct written forms, which these models may fail to recognize. Also, oftentimes, there is a mismatch between training datasets that are obtained for a target domain and actual speech samples. For instance, in a medical domain, the speaking speed of doctors is significantly faster than normal reading or conversation speech that can generally be obtained using synthesized training datasets. The recording speed of actual telephone conversations may also not be similar to what can be obtained using synthetically generated datasets. This results in lower performance of the models in a target domain environment.

Creating a dataset for training an ASR model in a particular target domain (e.g., a medical domain) is also an expensive process. The size of target domain data that can be collected is usually relatively small (e.g., 100 hours) due to the high cost of obtaining original transcripts pertaining to real speech samples. These samples have to further be transcribed and annotated prior to using them as training datasets making it an expensive process. Due to the high cost of creating target domain datasets for training an ASR model in a specific target domain, in some approaches, synthetically generated datasets can be constructed and provided as datasets to train an ASR system in a specific target domain. The synthetic datasets can be generated, for example, by using a Text-To-Speech (TTS) system that is capable of converting text to audio signals. The synthetically generated datasets are used as training datasets to train the ASR model and test its performance and accuracy in a particular target domain. However, the use of synthetic datasets as training datasets for the ASR model also has certain drawbacks. For instance, synthetic datasets that are generated for a target domain (e.g., a medical domain) often lack coverage in terms of speaking speeds, speaking styles, recording conditions and formats, demographic characteristics (e.g., age or gender) and linguistic variations.

The developed approach described herein addresses these challenges and others by providing techniques for constructing behavioral synthesized datasets for training an ASR model in a particular target domain. The synthesized datasets are constructed for a particular target domain using Text-To-Speech (TTS) system based on a set of terms and a set of templates. A set of terms and a set of templates specific to domain language usage in a target domain are accessed and a pre-trained language model is used to generate text samples (e.g., a set of sentences) based on the terms and templates. The text samples are then provided to a TTS system which then generates a set of behavioral synthesized test examples that can be used for training the ASR model in a particular target domain. In a certain implementation, the TTS system is a multiple speaker TTS system that includes capabilities to generate multiple audio samples for each text sample. The multiple audio files represent speech patterns corresponding to speakers of different ages, genders, accents, and styles.

By using a multiple speaker TTS system, lexicons, speaking speeds and styles, recording conditions and formats, demographic characteristics (i.e., age or gender) or linguistic variations (i.e., accents or dialects) are considered in the construction of the test examples. The synthesized test examples that are generated using a multiple speaker TTS system based on terms and templates that are specific to domain language usage in a specific target domain increase the coverage of speech benchmarking data, especially on those behavioral aspects that human-speech test data are not available yet due to the time and cost requirement to collect these samples. The behavioral synthesized test examples generated using the disclosed approach are further evaluated using various criteria and multiple subsets of test samples are formed based on the evaluation. A subset of test samples is then selected based on selection criteria and the selected subset of test samples is used to generate a training dataset to train the ASR model in a particular target domain.

In certain embodiments, a data augmentation technique is applied to the selected subset of test examples to generate a set of training examples for training the ASR model in a target domain. The data augmentation technique augments the selected subset of test examples with general domain datasets to generate a set of training examples for training the ASR model in the target domain. ASR models that are typically trained on only target domain specific speech data can suffer from certain drawbacks. For instance, these models can suffer from a catastrophic forgetting phenomenon which refers to a tendency of a model to abruptly and drastically forget previously learned information upon learning new information. By augmenting the ASR model with general domain datasets, the performance of the ASR model can further be improved in the target domain.

Using a combined dataset (e.g., a target domain dataset and a general domain dataset) for training an ASR model can, however, sometimes result in relatively long training times. This is due to the fact that the size of the dataset that can be obtained for a general domain (e.g., approximately 10,000 hours) is generally much larger than the size of a target domain dataset (e.g., approximately 100 hours). To minimize the training time, in certain embodiments, multiple groups and subgroups of training datasets are created based on the combined dataset. Sampling weights are then derived for these multiple groups of training data and a batch of training examples are randomly sampled from the various groups and subgroups. The ASR model is then fine-tuned using the sampled batch of training examples and an updated ASR model is generated. The updated ASR model is trained and deployed to a cloud infrastructure of a cloud service provider. For instance, in certain examples, the ASR model may be deployed to a cloud service (e.g., the speech service 110C) that implements an ASR system in a cloud infrastructure of a cloud service provider platform (e.g., 108).

In various embodiments, a computer-implemented method includes generating a set of test examples. The set of test examples includes multiple subsets of test examples. Each respective subset of test examples of the subsets of test examples corresponds to a particular test category of a plurality of test categories. For each respective subset of test examples of the subsets of test examples, a machine language model is used to convert audio samples of the respective subset of test examples to text transcripts. For each respective subset of test examples, a word error rate is determined for the respective subset of test examples by comparing the text transcripts to text samples corresponding to the audio samples of the respective subset of test examples. In certain examples, the word error rate for the respective subset of test examples is included in a set of word error rates for the set of test examples. A test category from multiple test categories is then selected based on the word error rates for the set of test examples and a set of training examples is generated from a selected subset of test examples of the subsets of test examples, where the selected subset of test examples corresponding to the test category.

As used herein, when an action is “based on” something, this means the action is based at least in part on at least a part of the something. As used herein, the terms “similarly,” “substantially,” “approximately” and “about” are defined as being largely but not necessarily wholly what is specified (and include wholly what is specified) as understood by one of ordinary skill in the art. In any disclosed embodiment, the term “similarly,” “substantially,” “approximately,” or “about” may be substituted with “within [a percentage] of” what is specified, where the percentage includes 0.1, 1, 5, and 10 percent.

### Automatic Speech Recognition (ASR) Model Training System

FIG. 2 is a simplified block diagram of an environment 200 incorporating an automatic speech recognition system and a model improvement system, according to certain embodiments. The automatic speech recognition (ASR) system 208 includes capabilities that enable users to perform various tasks via natural language-based conversations between the ASR system and its users. As part of a conversation, a user 202 may provide a user input 206 to the ASR system 208 and get a response 209 back from the ASR system 208. For instance, the user input 206 can be an audio input or a speech form (such as when a user says or speaks something) that is provided as input to the ASR system 208. The ASR system 208 then converts the audio input into a text transcript. The ASR system 208 may utilize various speech-to-text processing techniques to convert the audio input into a text transcript 211. For instance, in one implementation, the ASR system 208 may implement an Automatic Speech Recognition (ASR) model 210 (e.g., a machine learning model) that applies ASR technology to convert the audio input into a text transcript 211. In certain implementations, the text transcript may be stored in a persistent memory such as in a data store 214 of the ASR system.

The text transcript 211 generated by the ASR system 208 may further be processed by the ASR system 208 to provide a response 209 to the user 202. The ASR system 208 may process the text transcript by applying natural language understanding (NLU) techniques to understand the meaning of the user (audio) input 206. Upon understanding the meaning of the input, the ASR system 208 may perform one or more actions or operations responsive to the understood meaning or intent of the input and take appropriate actions. For example, a user input may request a pizza to be ordered by providing an utterance such as “I want to order a pizza.” Upon receiving such an utterance (audio input), the ASR system 208 performs processing to understand the meaning of the input and take an appropriate action. The appropriate action may involve, for example, responding to the user with questions requesting user input on the type of pizza the user desires to order, the size of the pizza, any toppings for the pizza, and the like. The response 209 provided by the ASR system 208 may also be in natural language form and typically in the same language as the audio input.

In certain implementations, and as depicted in FIG. 2, computing environment 200 also includes a model improvement system 212. The model improvement system 212 may be communicatively coupled to the ASR system 208 via one or more communication networks. The model improvement system 212 may be implemented by one or more computing systems that execute computer-readable instructions (e.g., code, program) to implement the model improvement system 212. The model improvement system 212 includes various subsystems such as a test example generation subsystem 214, a test example evaluation subsystem 216, and a training examples generation and model fine-tuning subsystem 218. In certain embodiments, and as will be described in greater detail below, the model improvement system 208 includes capabilities to train the ASR model 208 in a particular target domain by obtaining a set of test examples that are relevant to the target domain. The model improvement system 212 then evaluates the set of test examples and selects a subset of test examples based on various criteria. The model improvement system 212 then generates a set of training examples for training and fine-tuning the ASR model based on the selected subset of test examples. The trained ASR model is then deployed by the model improvement system 212 to the ASR system 208. The ASR system 208 may then use the deployed ASR model 210 to perform various functions related to speech recognition. For instance, the ASR system 208 may be configured to access an audio recording, provide the audio recording to the deployed ASR model 210 (i.e., the updated machine learning model), use the updated machine learning model to convert the audio recording to a transcript for the audio recording and store the transcript (e.g., 2111) in a storage medium of the cloud infrastructure.

Computing environment 200 depicted in FIG. 2 is merely an example and is not intended to unduly limit the scope of claimed embodiments. One of ordinary skill in the art would recognize many possible variations, alternatives, and modifications. For example, in some implementations, the ASR system 208 and the model improvement system 212 can be implemented using more or fewer subsystems than those shown in FIG. 2, may combine two or more subsystems, or may have a different configuration or arrangement of subsystems. Details related to the processing performed by the various systems of the model improvement system 212 are described below with respect to the flowchart depicted in FIG. 2 and the accompanying description.

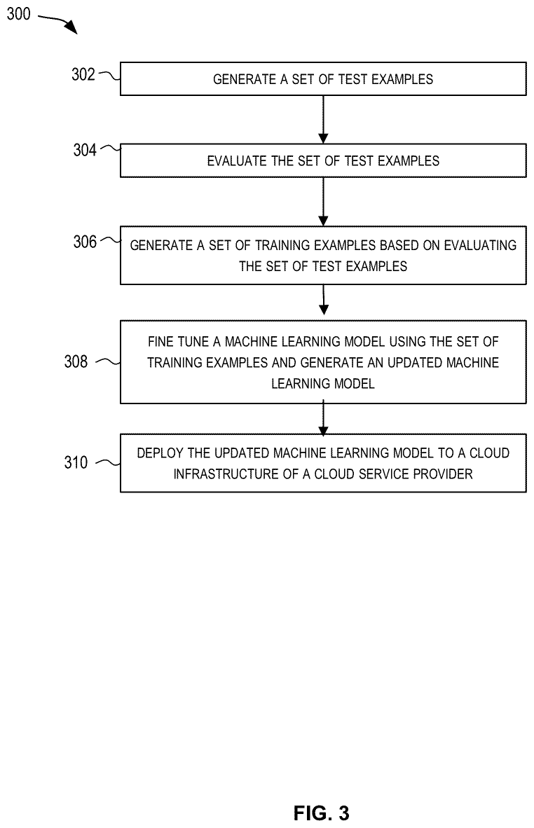

FIG. 3 is a process flow for generating a set of training examples for incrementally fine-tuning an Automatic Speech Recognition (ASR) model, according to certain embodiments. The processing depicted in FIG. 3 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 3 and described below is intended to be illustrative and non-limiting. Although FIG. 3 depicts the various processing steps occurring in a particular sequence or order, this is not intended to be limiting. In certain alternative embodiments, the steps may be performed in some different order, or some steps may also be performed in parallel. In certain embodiments, such as in the embodiment depicted in FIG. 1, the processing depicted in FIG. 3 may be performed by the subsystems (e.g., 214, 216 and 218) of the model improvement system 212.

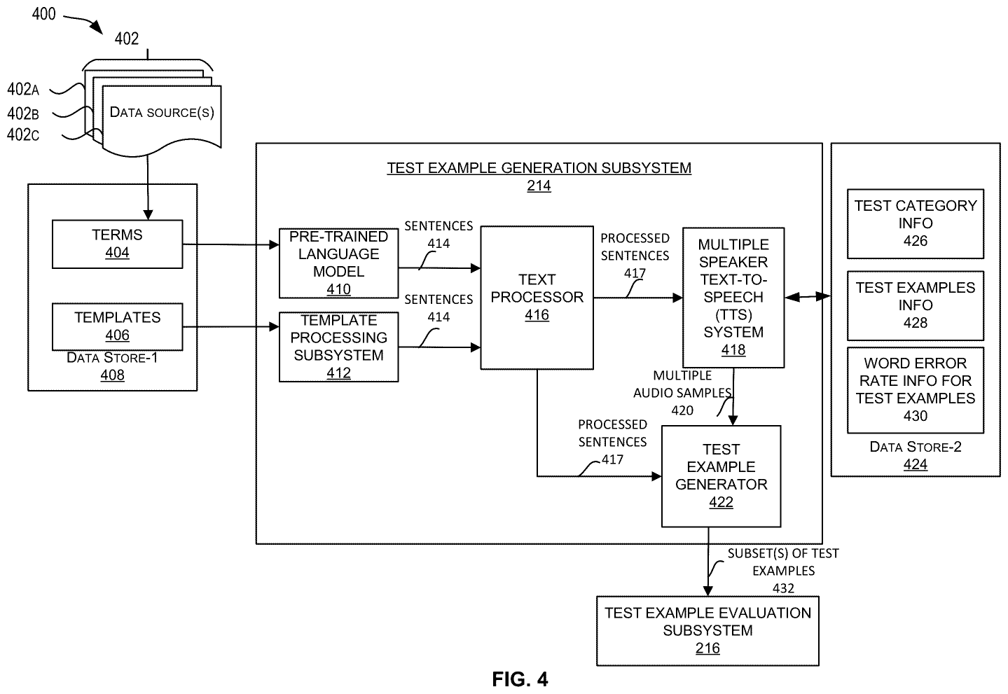

At block 302, the test example generation subsystem 214 generates a set of test examples for evaluating and fine-tuning training an ASR model. Details related to the processing performed by the test example generation subsystem 214 to generate a set of test examples is described in FIGS. 4-6.

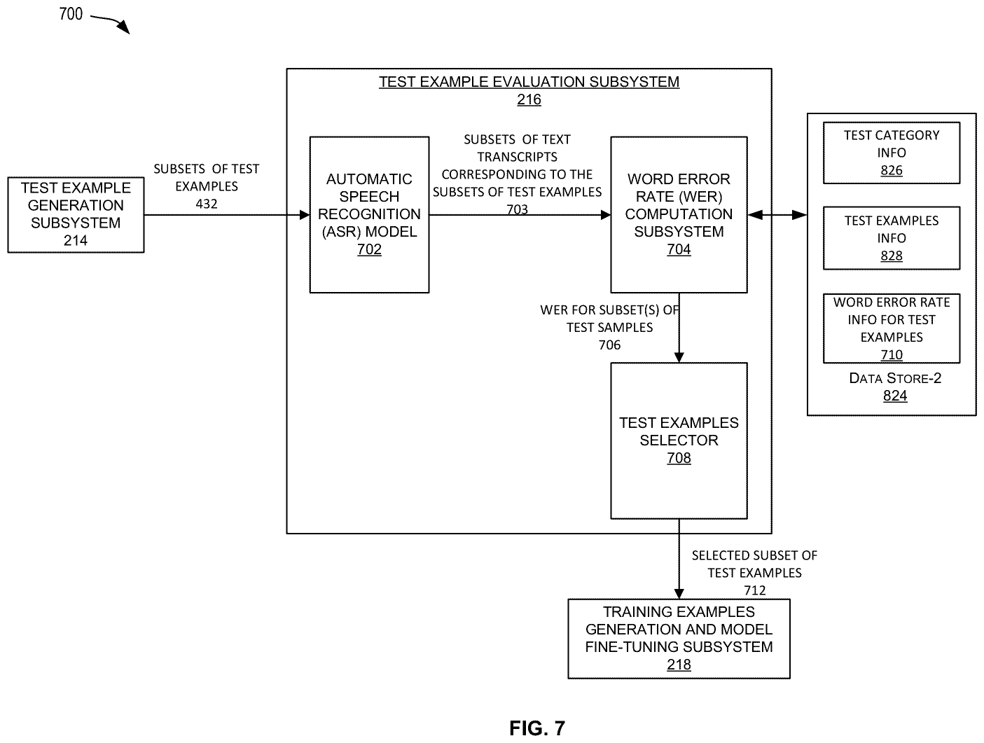

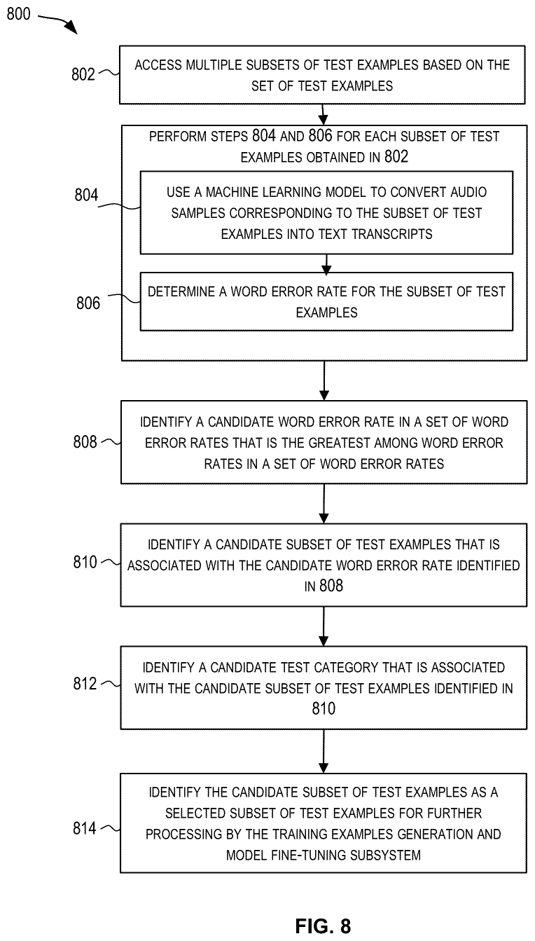

At block 304, the test example evaluation subsystem 216 evaluates the set of test examples based on various criteria. Details related to the processing performed by the test example evaluation subsystem 216 to evaluate a set of test examples is described in FIGS. 7-8.

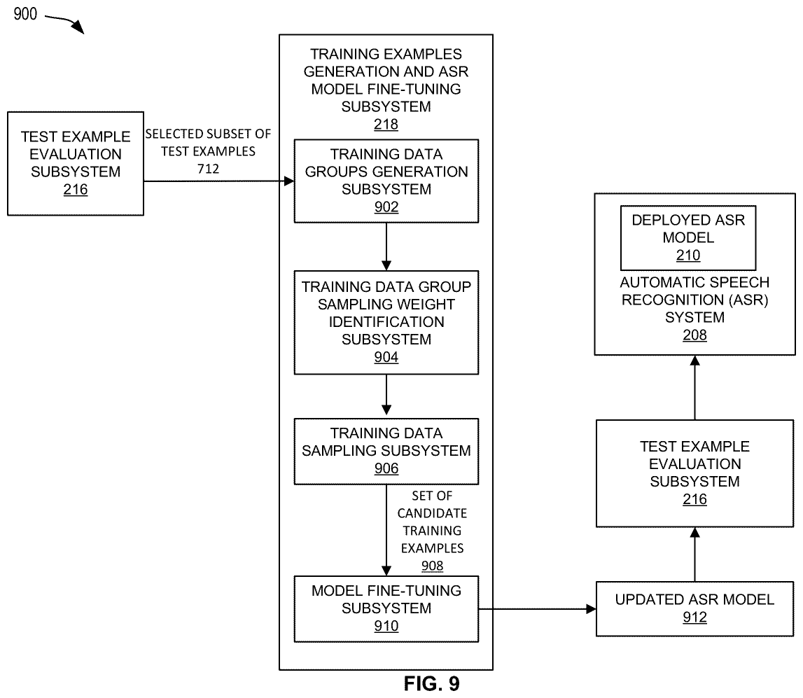

At block 306, the training examples generation and ASR model fine-tuning subsystem 218 generates a set of training examples based on evaluating the set of test examples using various criteria. At block 308, the subsystem 218 further fine-tunes the ASR model based on the set of training examples and generates an updated ASR model. The updated ASR model is deployed to a cloud infrastructure of a cloud service provider at block 310. For instance, in certain examples, and as depicted in FIG. 2, the ASR model 210 may be deployed to a cloud service (e.g., the speech service 110C) that implements an ASR system 208 in a cloud infrastructure of the cloud service provider platform 108. Details related to the processing performed by the training examples generation and ASR model fine-tuning subsystem 218 is described in FIGS. 9-12.

FIG. 4 is a simplified block diagram of the various subsystems and the interaction between the subsystems of the test example generation subsystem shown in FIG. 2, according to certain embodiments. The test example generation subsystem 214 may be implemented by one or more computing systems that execute computer-readable instructions (e.g., code, program) to implement the test example generation subsystem 214. As depicted in FIG. 4, the test example generation subsystem 214 may include various subsystems such as a pre-trained language model 410, a template processing subsystem 412, a text processor 416, a multiple speaker text-to-speech (TTS) system 418 and a test example generator 422. Portions of data or information used by or generated by the test example generation subsystem 214 as part of its processing may be stored in a persistent memory such as a data store-1 408 and a data store-2 424. For instance, the data store-1 408 may be configured to store information related to a set of terms 404 and a set of templates 406 used by the test example generation subsystem 214 for its processing. The data store-2 424 may be configured to store information related to test categories 426, test examples 428 and word error rates 430 that are generated or used by the test example generation subsystem 214 as part of its processing. The test example generation subsystem 214 can be implemented using more or fewer subsystems than those shown in FIG. 4, may combine two or more subsystems, or may have a different configuration or arrangement of subsystems.

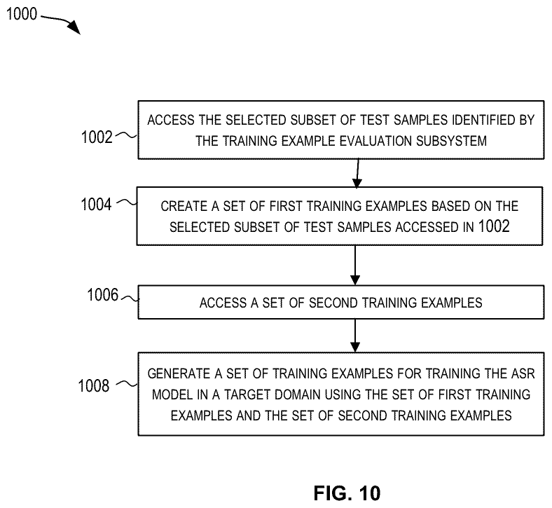

In certain embodiments, the test example generation subsystem 214 may be configured to generate a set of training examples (e.g., a set of audio samples) that can be used to train an ASR model in a particular target domain (e.g., a medical domain). To generate a set of test samples, the test example generation subsystem 214 performs multiple stages of processing. In a first stage of processing, the test example generation subsystem 214 obtains a set of text samples (e.g., a set of sentences 414) using a variety of techniques. For instance, in one approach, the text samples may be obtained using a pre-trained language model 410 and a set of terms 404. Details of the processing performed by the pre-trained language model 410 to generate a set sentences based on a set of terms is described in FIG. 9. In another approach, the text samples may be obtained by a template processing subsystem 412 using a set of pre-defined templates 406. Details of the processing performed by the template processing subsystem 412 to generate a set of sentences based on a set of templates is described in FIG. 10.

In a second stage of processing, the text samples (i.e., a set of sentences 416) are processed by a text processor 416 using various processing techniques. Details of the various types of processing that can be applied to the set of sentences is described in FIG. 9. In a third stage of processing, the text processor 416 provides a set of processed sentences 417 to a multiple-speaker TTS system 418 which generates a set of audio samples based on the set of processed sentences. The multiple-speaker TTS system 418 is capable of generating speech in real-time by considering a speaker's individual characteristics using a speech reference of their voice and a text sample as input. The multiple-speaker TTS system 418 comprises a set of models (e.g., deep neural networks) that are trained to recognize a speech pattern corresponding to a specific speaker using a large amount of speech data recorded from the specific speaker. The multiple-speaker TTS system 418 is capable of generating different audio files for speakers of different ages, genders, accents, and styles, where each audio file represents a speech pattern corresponding to a type of speaker.

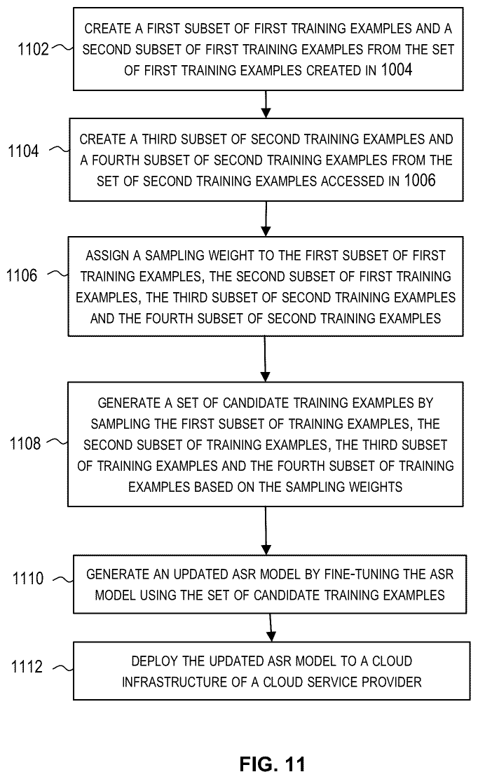

In a fourth stage of processing, the set of audio samples and a subset of the processed sentences 417 are further processed by a test example generator 422 within the text example generation subsystem to generate a set of test examples. In certain implementations, the test example generator 422 is configured to form (generate) multiple subsets of test examples 432 from the set of test examples. Each subset of test examples comprises a set of audio signals that correspond to a particular test category. The test categories may represent various speaker categories such as speakers of different ages, genders, accents, and styles. Information related to the different test categories may be stored as part of test category information 426 in the data store-2 424 of the test example generation system 418. For instance, a first subset of test examples can comprise a set of audio signals that correspond to a speech pattern of a male speaker, second subset of test examples can comprise a set of audio signals that correspond to a speech pattern of a female speaker, a third subset of test examples can comprise a set of audio signals that correspond to a speech pattern of a speaker speaking in a particular dialect and so on. In certain examples, information related to the subsets of test samples may be stored as test examples information 428 in the data store-2 424 of the test example generation subsystem. The subset of test examples are then evaluated by a test example evaluation subsystem 216. Details of processing performed by the test example evaluation subsystem 216 to evaluate the subset of test examples is described in FIG. 11.

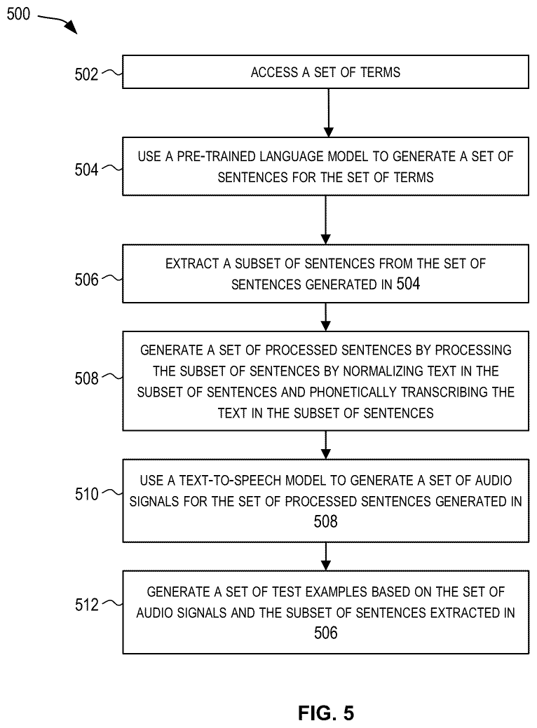

FIG. 5 describes a process flow for generating a set of test examples by processing a set of sentences, where the set of sentences are obtained using a pre-trained language model and a set of terms, according to certain embodiments. The processing depicted in FIG. 5 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 5 and described below is intended to be illustrative and non-limiting. Although FIG. 5 depicts the various processing steps occurring in a particular sequence or order, this is not intended to be limiting. In certain alternative embodiments, the steps may be performed in some different order, or some steps may also be performed in parallel. In certain embodiments, such as in the embodiment depicted in FIG. 2, the processing depicted in FIG. 5 may be performed by one or more systems (e.g., 410, 416, 418 and 422) of the text example generation subsystem 214 in the model improvement system 212.

At block 502, the pre-trained language model 410 obtains a set of terms for generating a set of test examples. The set of terms 404 may be obtained from a diverse set of data sources (e.g., 402A, 402B and 402C). In certain examples, the set of data sources comprise medical domain information such as medical conversation transcripts, medical notes, medical reports and so on. The set of terms 404 comprise a list of medical lexicons related to a target medical specialty in the medical domain that can be extracted from the set of data sources. For instance, the set of terms 404 may correspond to a list of relevant medical lexicons related to a target medical specialty such as “family medicine” or “cardiology.”

At block 504, the pre-trained language model generates a set of sentences for the set of terms. The pre-trained language model 410 may represent a machine learning (ML) model that has been trained on a large corpus of data. Through this training, the model learns the language's general rules for word usage and how it is written. The model is then trained with a task-specific dataset, e.g., to generate a set of sentences 414 based on a set of terms 404.

At block 506, the set of sentences are processed by a text processor 416 in the test example generation subsystem 214. The processing performed by the text processor 416 may involve extracting a subset of sentences from the set of sentences. The text processor 416 may utilize various techniques to extract a subset of sentences from the set of sentences. For instance, in one example, a subset of sentences may be extracted by removing outlier sentences that are either too long or too short. In another example, a subset of sentences may be extracted by identifying sentences that contain specific medical terms where only sentences that contain at least one of the identified medical terms are kept and the other sentences are filtered out.

At block 508, the text processor 410 further processes the subset of sentences extracted in 506 by normalizing the text in the subset of sentences and phonetically transcribing the text in the subset of sentences. Text normalization refers to the process of converting informal text into a suitable standard format using a next normalization tool. To phonetically transcribe text in a sentence, all the words in spoken-form are checked against a pronunciation dictionary used by the multiple-speaker TTS system. If a word is not in the TTS pronunciation dictionary, its pronunciation, i.e., a phoneme sequence, is be derived. These new pronunciations are then added to the TTS pronunciation dictionary or can be injected to the spoken-form text before being sent to the TTS system. The examples shown below illustrate different examples of input sentences that are processed by the text processor 406 as part of the processing performed in block 508 to generate a set of processed sentences.

### Example 1

Input Sentence: lisinopril 10 mg PO BID number 30 refills 3 substitutions permitted
Processed Sentence: <phoneme alphabet=‘arpabet’ ph=‘L IH0 S IH1 N AH0 P R IH2 L’>lisinopril</phoneme>ten milligrams po, bid, number thirty, refills three, substitutions permitted.

### Example 2

Input Sentence: Hey, Cerner, please let Dr. Cutler know that I admitted her patient to the hospital today in diabetic ketoacidosis
Processed Sentence: Hey, Cerner, please let doctor cutler know that I admitted her patient to the hospital today in diabetic <phoneme alphabet=‘arpabet’ ph=‘K IY2 T OW0 AE2 S AH0 D OW1 S AH0 S’>ketoacidosis</phoneme>.

### Example 3

Input Sentence: I see your last hemoglobin A1C was eight and I'm really worried that you're trending up again.
Processed Sentence: I see your last hemoglobin <phoneme alphabet=‘arpabet’ ph=‘EY1 W AH1 N SIY1’>A1C</phoneme> was eight and I'm really worried that you're trending up again.

At block 510, the set of processed sentences are provided to a multiple-speaker TTS system 418 which then generates (synthesizes) a set of audio (speech) samples for each processed sentence. In certain implementations, the multiple speaker TTS system can be configured to synthesize multiple audio samples for each sentence. Each audio sample in the multiple audio samples may represent a voice having a unique speech pattern of a particular speaker. For instance, the speakers can be of different ages, genders or have different accents or speaking styles.

At block 512, the test example generator 422 generates a set of test examples based on the set of audio signals and the subset of sentences extracted in 506. The set of test examples 432 may be stored as part of test examples information 428 in data store-2 424 of the test example generation subsystem 214. The test examples information 428 may additionally include the original text samples (i.e., sentences) corresponding to the set of audio samples. In certain implementations, the test example generator 422 forms (generates) multiple subsets of test examples from the set of test examples and stores the multiple subsets of test examples as part of the text examples information 428. Each subset of test examples is associated with a particular test category. The test category for each subset of test examples is determined based on test category information 426 stored in data store-2 424 of the test example generation subsystem 214. The test category information 426 may comprise information related to various types (categories) of speakers. The various categories of speakers may include, but are not limited to, male speakers, female speakers, speakers speaking in a particular dialect, speakers with a particular accent, speakers with a particular speaking speed, and so on.

For instance, a first subset of test examples can comprise a set of audio signals that correspond to a speech pattern of a male speaker, second subset of test examples can comprise a set of audio signals that correspond to a speech pattern of a female speaker, a third subset of test examples can comprise a set of audio signals that correspond to a speech pattern of a speaker speaking in a particular dialect and so on. The subsets of test examples are then evaluated by a test example evaluation subsystem 216. Details of processing performed by the test example evaluation subsystem 216 to evaluate the subset of test examples is described in FIG. 11.

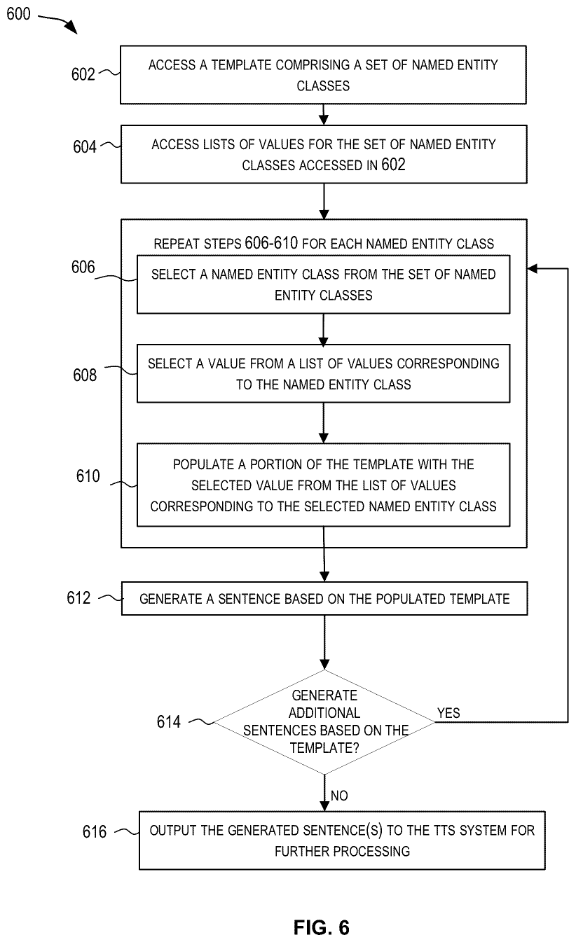

The processing described in FIG. 5 described a particular approach for generating a set of test examples by processing a set of sentences, where the set of sentences are obtained using a pre-trained language model and a set of terms. In certain cases, the set of terms (e.g., 404) that can be identified and selected from a set of data sources (e.g., 402A, 402B, 402C) may not be adequate to cover a diverse set of terms that are required to generate a test of examples for testing the performance of the ASR system in a particular target domain. For example, for a text corpus pertaining to a medical domain, some drug names, or medical named entities (e.g., dose, route, frequency, and the like) may not appear in any of the terms that are extracted from the data sources. To generate more lexicon variations for the same syntactic sentence, in another approach (described in FIG. 6), pre-defined templates may be used to construct a set of sentences.

FIG. 6 describes a process flow for constructing a set of sentences based on a template, according to certain embodiments. The processing depicted in FIG. 6 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 6 and described below is intended to be illustrative and non-limiting. Although FIG. 6 depicts the various processing steps occurring in a particular sequence or order, this is not intended to be limiting. In certain alternative embodiments, the steps may be performed in some different order, or some steps may also be performed in parallel. In certain embodiments, such as in the embodiment depicted in FIG. 2, the processing depicted in FIG. 6 may be performed by the template processing subsystem 412 in the text example generation subsystem 214.

At block 602, the template processing subsystem 412 accesses a template from a set of templates (e.g., 406) stored in a data store-1 408 of the test example generation subsystem 214. In a certain implementations, the set of templates 406 correspond to medical order templates that describe a medication for a patient that can be ordered from a pharmacy or supplier. An example of a medical order template is shown below:
Medical order template: “<MEDICATION><DOSE_AMOUNT><DOSE_UNIT><ROUTE><FREQUENCY> number <DISPENSE_AMOUNT><REFILL>.”

As part of the processing performed in block 602, the template processing subsystem 412 additionally accesses a set of named entity classes corresponding to the template. For example, for the medical order template shown above, <MEDICATION><DOSE_AMOUNT><DOSE_UNIT><ROUTE><FREQUENCY><DISPENSE_AMOUNT> and <REFILL> represent the named entity classes for the medical order template.

At block 604, the template processing subsystem 412 accesses lists of values for the set of named entity classes accessed in 602. In certain examples, a named entity class that is defined in a template may comprise multiple lists of values. Example 4 illustrates one or more lists of values corresponding to the <MEDICATION> named entity class.

### Example 4

MEDICATION = [
{‘raw_text’: ‘doxycycline’,
‘normalized_text’: ‘doxycycline’,
‘phoneme’: ‘D AA2 K S AH0 S AY1 K L IY2 N’,
},
{‘raw_text’: ‘paracetamol’,
‘normalized_text’: ‘paracetamol’,
‘phoneme’: ‘P EH2 R AH0 S IY1 T AH0 M AO2 L’,
},
{‘raw_text’: ‘fentanyl’,
‘normalized_text’: ‘fentanyl’,
‘phoneme’: ‘F EH1 N T AH0 N IH2 L’,
},
]

For instance, in example 4 shown above, the <MEDICATION> named entity class comprises three lists of values. The first list of values represents information (i.e., the raw text, the normalized text and the phoneme) related to a first type of medication (doxycycline), the second list of values represents information (i.e., the raw text, the normalized text and the phoneme) that is related to a second type of medication (‘paracetamol’) and the third list of values represents information (i.e., the raw text, the normalized text and the phoneme) that is related to a third type of medication (‘fentanyl’). While example 4 illustrates a named entity class with three lists of values, in other embodiments, a named entity class can be associated with more or fewer lists of values that what is illustrated in example 4.

Additional examples of lists of values for named entity classes for a medical order template are illustrated in the examples below. For instance, example 5 illustrates one or more lists of values corresponding to the <DOSE_AMOUNT> named entity class, example 6 illustrates one or more lists of values corresponding to the <DOSE_UNIT> named entity class, example 7 illustrates one or more lists of values corresponding to the <DOSE_UNIT> named entity class, example 8 illustrates one or more lists of values corresponding to the <ROUTE> named entity class, example 9 illustrates one or more lists of values corresponding to the <FREQUENCY> named entity class, example 10 illustrates one or more lists of values corresponding to the <DISPENSE_AMOUNT> named entity class and example 11 illustrates one or more lists of values corresponding to the <REFILL> named entity class.

### Example 5

DOSE_AMOUNT = [
{‘raw_text’: 50},
{‘raw_text’: 75},
{‘raw_text’: 100},
]

### Example 6

DOSE_UNIT = [
{‘raw_text’: ‘mg’,
‘normalized_text’: ‘milligrams’,
‘phoneme’: None,
},
]

### Example 7

ROUTE = [
{‘raw_text’: ‘P.O.’,
‘normalized_text’: ‘P O’,
‘phoneme’: None,
},
]

### Example 8

FREQUENCY = [
{‘raw_text’: ‘B.D.’,
‘normalized_text’: ‘B D’,
‘phoneme’: None,
‘note’: ‘twice daily’,
},
{‘raw_text’: ‘B.I.D.’,
‘normalized_text’: ‘B I D’,
‘phoneme’: None,
‘note’: ‘twice daily’,
},
{‘raw_text’: ‘Q.A.D.’,
‘normalized_text’: ‘Q A D’,
‘phoneme’: None,
‘note’: ‘every other day’,
},
{‘raw_text’: ‘Q.A.M.’,
‘normalized_text’: ‘Q A M’,
‘phoneme’: None,
‘note’: ‘every day before noon’,
},
{‘raw_text’: ‘Q.D.S.’,
‘normalized_text’: ‘Q D S’,
‘phoneme’: None,
‘note’: ‘four times a day’,
},
{‘raw_text’: ‘Q.P.M.’,
‘normalized_text’: ‘Q P M’,
‘phoneme’: None,
‘note’: ‘every day after noon’,
},
{‘raw_text’: ‘Q.H.’,
‘normalized_text’: ‘Q H’,
‘phoneme’: None,
‘note’: ‘every hour’,
},
{‘raw_text’: ‘Q.H.S.’,
‘normalized_text’: ‘Q H S’,
‘phoneme’: None,
‘note’: ‘every night at bedtime’
},
{‘raw_text’: ‘Q.D.’,
‘normalized_text’: ‘Q D’,
‘phoneme’: None,
‘note’: ‘every day’,
},
{‘raw_text’: ‘Q.I.D.’,
‘normalized_text’: ‘Q I D’,
‘phoneme’: None,
‘note’: ‘four times a day’,
},
{‘raw_text’: ‘Q.O.D.’,
‘normalized_text’: ‘Q O D’,
‘phoneme’: None,
‘note’: ‘every other day’,
},
{‘raw_text’: ‘QQH’,
‘normalized_text’: ‘Q Q H’,
‘phoneme’: None,
‘note’: ‘every four hours',
},
{‘raw_text’: ‘QWK’,
‘normalized_text’: ‘Q W K’,
‘phoneme’: None,
‘note’: ‘every week’,
},
]

### Example 9

DISPENSE_AMOUNT = [
{‘raw_text’: 3},
{‘raw_text’: 7},
{‘raw_text’: 14},
{‘raw_text’: 21},
{‘raw_text’: 28},
{‘raw_text’: 30},
]

### Example 10

REFILL = [
{‘raw_text’: ‘no refils’,
‘normalized_text’: None,
‘phoneme’: None,
},
{‘raw_text’: ‘refils 1’,
‘normalized_text’: None,
‘phoneme’: None,
},
{‘raw_text’: ‘refils 2’,
‘normalized_text’: None,
‘phoneme’: None,
},
{‘raw_text’: ‘refils times 3’,
‘normalized_text’: None,
‘phoneme’: None,
},
]
named_entities = [
{‘tag_name’: ‘<MEDICATION>’,
‘tag_values’: MEDICATION,
},
{‘tag_name’: ‘<DOSE_AMOUNT>’,
‘tag_values’: DOSE_AMOUNT,
},
{‘tag_name’: ‘<DOSE_UNIT>’,
‘tag_values’: DOSE_UNIT,
},
{‘tag_name’: ‘<ROUTE>’,
‘tag_values’: ROUTE,
},
{‘tag_name’: ‘<FREQUENCY>’,
‘tag_values’: FREQUENCY,
},
{‘tag_name’: ‘<DISPENSE_AMOUNT>’,
‘tag_values’: DISPENSE_AMOUNT,
},
{‘tag_name’: ‘<REFILL>’,
‘tag_values’: REFILL,
},
]

After accessing the lists of values for the set of named entity classes as described above, the template processing subsystem performs the operations described in blocks 606-610 for each named entity class corresponding to the template accessed in 602. As part of the processing performed in block 606, the template processing subsystem first selects a named entity class (e.g., MEDICATION) from the set of named entity classes. At block 608, the template processing subsystem selects a value (e.g., ‘doxycycline’) from a list of values (‘doxycycline’ ‘paracetamol’ and ‘fentanyl’) corresponding to the selected named entity class. At block 610, the template processing subsystem populates a portion of the template with the selected value from the list of values corresponding to the selected named entity class.

At block 612, the template processing subsystem generates a sentence based on the populated template. An example of a sentence that is generated based on a populated template is shown in example 11 below:

### Example 11: Doxycycline 50 mg P.O. B.D. Number 3 No Refils

In certain examples, the processes described in 606-610 may be iteratively performed by the template processing system a certain number (e.g., 3-5) of times to generate additional sentences for the template accessed in 602. Examples of additional sentences that can be generated for the medical order template by the template processing system are shown in examples 13-15 below:

### Example 13: Doxycycline 50 mg P.O. B.D. Number 3 Refils 1

### Example 14: Doxycycline 50 mg P.O. Q.O.D. Number 3 Refils 1

### Example 15: Fentanyl 75 mg P.O. Q.D.S. Number 28 Refils 1

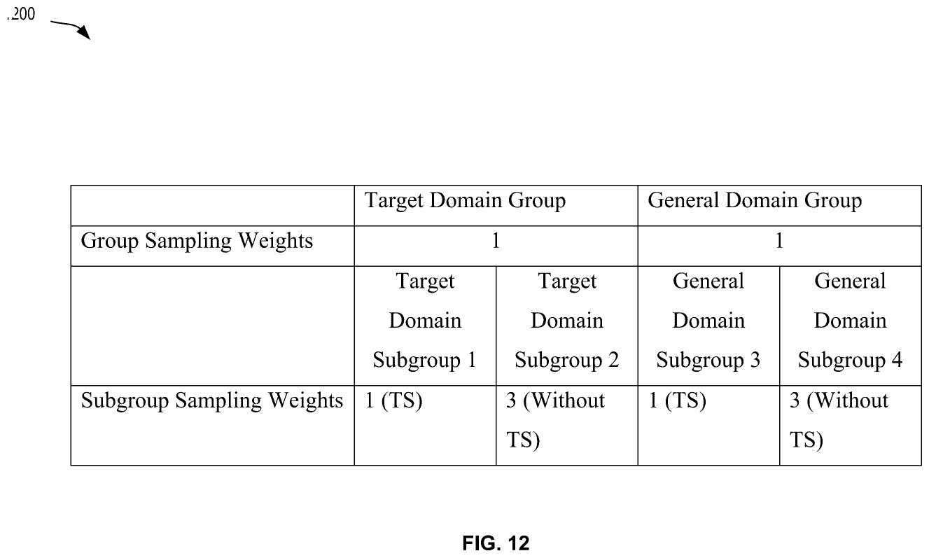

At block 616, the template processing subsystem outputs the generated sentence(s) to the multiple speaker TTS system 818 for further processing. The set of test examples are then evaluated by the test example evaluation subsystem. Details of the processing performed by the test example evaluation subsystem 216 to evaluate the subset of test examples is described in FIG. 7 and FIG. 12 below.

FIG. 7 is a simplified block diagram of the various subsystems of the test example evaluation subsystem 216 and the interaction between the subsystems, according to certain embodiments. The test example evaluation subsystem 216 may be implemented by one or more computing systems that execute computer-readable instructions (e.g., code, program) to implement the test example evaluation subsystem 216. As depicted in FIG. 7, the test example evaluation subsystem 216 may include various subsystems such as an Automatic Speech Recognition (ASR) model 702, a Word Error Rate (WER) computation subsystem 704 and a test examples selector 708. Portions of data or information used by or generated by the test example evaluation subsystem as part of its processing may be stored in a persistent memory such as a data store-2 424. The data store-2 424 may be configured to store information related to test categories 426, test examples 428 and word error rates 430 that are generated or used by the test example evaluation subsystem 216 as part of its processing. In some implementations, the test example evaluation subsystem 216 can be implemented using more or fewer subsystems than those shown in FIG. 7, may combine two or more subsystems, or may have a different configuration or arrangement of subsystems.

In certain embodiments, the test example evaluation subsystem 216 may be configured to evaluate the subsets of test examples 434 generated by the test example generation subsystem 214. To evaluate the subsets of test samples, the test example evaluation subsystem first uses a machine learning model (e.g., an Automatic Speech Recognition (ASR) model) to convert audio samples of the respective subsets of test examples into corresponding subsets of text transcripts. The subsets of text transcripts 703 are then provided to the WER computation system 704 for further analysis. The WER computation system 704 determines a word error rate for each subset of test examples by comparing the subset of text transcripts 703 to original text samples (e.g., sentences) corresponding to the audio samples of the respective subset of test examples 432. In a certain implementation, the WER computation system 704 may obtain information related to the original text samples (e.g., a sentences) from the test examples information 428 stored in the data store-2 424 to compute the WERs for the subsets of test examples. The WER computation system 704 may further be configured to store the WERs for the subsets of test samples in the word error rate information 710 of the data store-2 424. Details of the processing performed by the WER computation system 704 to determine a word error rate for each subset of test examples is described in FIG. 12.

A test examples selector 708 in the test example evaluation subsystem then selects a subset of test examples from the multiple subsets of test examples based on the WER computed for each subset of test examples. Details of the processing performed by the test examples selector 708 to select a subset of test examples is described in FIG. 12. The selected subset of test examples 712 are then provided to a training example generation subsystem 218 to generate a set of training examples to be used for training the ASR model in a particular target domain.

FIG. 8 describes a process flow for evaluating a set of test examples, according to certain embodiments. The processing depicted in FIG. 8 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 8 and described below is intended to be illustrative and non-limiting. Although FIG. 8 depicts the various processing steps occurring in a particular sequence or order, this is not intended to be limiting. In certain alternative embodiments, the steps may be performed in some different order, or some steps may also be performed in parallel. In certain embodiments, such as in the embodiment depicted in FIG. 7, the processing depicted in FIG. 8 may be performed by one or more subsystems (e.g., 702, 704 and 708) of the test example evaluation subsystem 216.

At block 802, the test example evaluation subsystem 216 obtains multiple subsets of test samples (e.g., 432) from the test example generation subsystem 214. The test example evaluation subsystem 216 then performs the operations described in blocks 804 and 806 for each subset of test examples obtained in block 802. At block 804, the test example evaluation subsystem 216 uses a machine learning model (e.g., the ASR model 702) to convert audio samples corresponding to the subset of test examples into text transcripts. At block 806, the test example evaluation subsystem 216 determines a word error rate (WER) for the subset of test samples. The WER is a measure of how accurately the ASR model performs. In the process of recognizing speech and translating it into text form, some words may be left out or mistranslated by the ASR model. The WER computes the number of “errors” in a text transcript produced by an ASR model when compared to the original text sample (which can be for instance, a human transcription or a synthetically generated text sample). A lower WER generally indicates that the ASR model is more accurate in recognizing speech, while a higher WER generally indicates lower ASR model accuracy.

The test example evaluation subsystem 216 may utilize a variety of techniques to compute the WER for a subset of test samples. In one implementation, the WER for a subset of test samples is determined by computing the WER for each text sample (i.e., sentence) corresponding to an audio sample in the subset of test samples. The WER for each text sample is computed by dividing the number of correctly recognized lexicons in the text transcript corresponding to the audio signal by the number of lexicons in the original text sample (also referred to herein as the original transcript or gold transcript). The WERs computed for the text samples corresponding to the audio samples in the subset of test samples is then averaged to determine the WER for the subset of test samples. In certain examples, the WER for each subset of test samples is stored in the WER information 424 in the data store-2 424 of the model improvement system.

At block 808, the test example evaluation subsystem 216 identifies a candidate WER in a set of WERs (e.g., stored in the data store-2 424) that is greatest among the WERs in the set of WERs.

At block 810, the test example evaluation subsystem 216 identifies a candidate subset of test samples that is associated with the candidate WER identified in 808.

At block 812, the test example evaluation subsystem 216 identifies a test category that is associated with the candidate subset of test examples identified in 810. In certain examples, the test category is identified based on the test category information 426 that is associated with the subsets of test examples stored in the data store-2 424.

At block 814, the test example evaluation subsystem 216 identifies the candidate subset of test examples as a selected subset of test examples for further processing by the training examples generation and model fine-tuning subsystem. As will be described in detail in FIGS. 9-11 below, the training examples generation and model fine-tuning subsystem uses the candidate subset of test examples to generate a set of training examples for training the ASR model in a particular target domain.

FIG. 9 is a simplified block diagram of the various subsystems and the interaction between the subsystems of the training examples generation and model fine-tuning subsystem shown in FIG. 2, according to certain embodiments. The training examples generation and model fine-tuning subsystem 218 may be implemented by one or more computing systems that execute computer-readable instructions (e.g., code, program) to implement the training examples generation and model fine-tuning subsystem 218. As depicted in FIG. 9, the training examples generation and model fine-tuning subsystem 218 may include various subsystems such as a training data groups generation subsystem 902, a training data group sampling weight identification subsystem 904, a training data sampling subsystem 906, and a model fine-tuning subsystem 910. In some implementations, the training examples generation and model fine-tuning subsystem 218 can be implemented using more or fewer subsystems than those shown in FIG. 9, may combine two or more subsystems, or may have a different configuration or arrangement of subsystems.

In certain embodiments, the training examples generation and model fine-tuning subsystem 218 is configured to obtain a selected subset of test examples 712 for processing. The selected subset of test examples may be identified by the training example evaluation subsystem 214 described in FIGS. 7 and 8. The training examples generation and model fine-tuning subsystem 218 then accesses general domain training datasets to be used for training the ASR model. As previously described, ASR models that are typically trained on only target domain specific data can suffer from certain drawbacks. For instance, these models can suffer from a catastrophic forgetting phenomenon which refers to a tendency of a model to abruptly and drastically forget previously learned information upon learning new information. By augmenting the ASR model with general domain datasets to generate a set of training examples, the performance of the ASR model can further be improved in the target domain.

In certain implementations, the ASR model that is trained using a set of training examples that are generated using a combination of datasets (i.e., target domain datasets and general domain datasets) as described above is further fine-tuned by creating multiple subgroups of training data sets from the set of training examples. The fine-tuning of the ASR model is performed to minimize the training time required for training the ASR model using a combination of datasets. As previously described, using a combined dataset (e.g., a target domain dataset and a general domain dataset) for training an ASR model in a target domain may sometimes result in relatively long training times for the ASR model. This is due to the fact that the size of the dataset that can be obtained for a target domain is generally much smaller than the size of a general domain dataset. These data imbalances can result in longer training times for training the ASR model. To minimize the training time, in certain embodiments, the ASR model is further fine-tuned by creating multiple training datasets (multiple data groups) from the set of training examples. Sampling weights are then derived for these multiple data groups and random sampling is applied to the multiple data groups to obtain a training data batch for training the ASR model.

In certain examples, the fine-tuning process is performed by the subsystems 902, 904, 906, and 910 within the subsystem 218. Additional details of the fine-tuning process is described in FIG. 10 and FIG. 11. As a result of the fine-tuning process, a set of candidate training examples 908 is provided as a training dataset to the model fine-tuning subsystem 910 for fine-tuning the ASR model. The model fine-tuning subsystem 910 generates an updated machine learning model (ASR model 912) by fine-tuning the ASR model (702) using the set of candidate training examples 908 and provides the updated ASR model 912 to the test example evaluation subsystem 216. The test example evaluation subsystem 216 evaluates the updated ASR model and deploys the updated machine learning model (ASR model) to a cloud service which implements an ASR system of a cloud service provider (e.g., the ASR system 208 shown in FIG. 2).

FIG. 10 describes a process flow for generating a set of training examples for training an automatic speech recognition (ASR) model in a target domain, according to certain embodiments. The processing depicted in FIG. 10 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 10 and described below is intended to be illustrative and non-limiting. Although FIG. 10 depicts the various processing steps occurring in a particular sequence or order, this is not intended to be limiting. In certain alternative embodiments, the steps may be performed in some different order, or some steps may also be performed in parallel. In certain embodiments, such as in the embodiment depicted in FIG. 10, the processing depicted in FIG. 10 may be performed by the training data groups generation subsystem 902 in the training examples generation and ASR model fine-tuning subsystem 218.

At block 1002, the training data groups generation subsystem 902 accesses the selected subset of test samples identified by the training example evaluation subsystem 214 to be used for training the ASR system. In one implementation, the selected subset of test samples represent target domain specific data for training the ASR model in a particular target domain. As described in FIG. 8, the selected subset of test examples may represent a set of speech data samples having the greatest word error rate (WER) among a set of WERs determined for the multiple subsets of test examples provided for evaluation. The selected subset of test examples is further associated with a particular test category. As previously described, the test categories may represent various speaker categories such as speakers of different ages, genders, accents, and styles. For instance, the selected subset of test examples, in one example, can comprise a set of audio signals that correspond to a speech pattern of a speaker speaking in a particular dialect.

At block 1004, the training data groups generation subsystem 902 creates a set of first training examples based on the selected subset of test examples accessed in 1002.

At block 1006, the training data groups generation subsystem 902 accesses a set of second training examples. In certain examples, the set of second training examples represent general domain data that is used for training the ASR model.

At block 1008, the training data groups generation subsystem 902 generates a set of training examples for training the ASR model in a target domain by augmenting the set of first training examples with the set of second training examples using a data augmentation technique. In certain implementations, the ASR model that is trained using the combination of datasets (i.e., target domain datasets and general domain datasets) is further fine-tuned by creating multiple subgroups of training data sets from the set of training examples. In certain examples, a total speech time that is associated with the set of training examples is greater than a total speech time associated with the selected subset of test examples. Details related to the process of fine-tuning the ASR model is described in FIG. 11 below.

FIG. 11 describes a process flow for fine-tuning an automatic speech recognition (ASR) model based on a set of training examples, according to certain embodiments. The processing depicted in FIG. 11 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 11 and described below is intended to be illustrative and non-limiting. Although FIG. 11 depicts the various processing steps occurring in a particular sequence or order, this is not intended to be limiting. In certain alternative embodiments, the steps may be performed in some different order, or some steps may also be performed in parallel. In certain embodiments, such as in the embodiment depicted in FIG. 11, the processing depicted in FIG. 11 may be performed by the subsystems (902, 904 and 906) within the training examples generation and fine-tuning subsystem 218.

In certain implementations, the process of fine-tuning the ASR model is initiated at block 1102 by the training data groups generation subsystem 902 by creating multiple subgroups of training datasets from the set of first training examples (i.e., the target domain specific data). The multiple subgroups may comprise a first subgroup (first subset) of first training examples and a second subgroup (second subset) of first training examples. In certain examples, the first subgroup comprises training examples with timestamps and the second subgroup comprises training examples without timestamps.

At block 1104, the training data groups generation subsystem 902 creates multiple subgroups of training datasets from the set of second training examples (i.e., the general domain data). In certain examples, the multiple subgroups may comprise a third subgroup (third subset of second training examples) that comprise training examples with timestamps and a fourth subgroup (fourth subset of second training examples) that comprise training examples without timestamps.

At block 1106, the training data group sampling weight identification subsystem 904 identifies a sampling weight to be assigned to the first subset of first training examples, the second subset of first training examples, the third subset of second training examples, and the fourth subset of second training examples. In certain approaches, the sampling weights are manually derived by a user (e.g., an administrator) of the model improvement system. In other approaches, the sampling weights may be derived automatically using a hyperparameter tuning process. Hyperparameter tuning refers to a process of identifying and selecting the optimal hyperparameters for use in training a machine learning model. Hyperparameters can be used to tune the performance of a model and can have a significant impact on the model's accuracy. In a certain implementation, hyperparameter tuning is used to determine sampling weights to be assigned to different groups of training examples such that the loss function computed for the batch of samples that is randomly drawn from the training dataset is minimized.

FIG. 12 depicts a table that illustrates a set of sampling weights that can be assigned to the various groups and subgroups of training datasets created using a combination of general domain datasets and target domain datasets, according to certain embodiments. The table of sampling weights depicted in FIG. 12 is merely an example and is not intended to unduly limit the scope of claimed embodiments. One of ordinary skill in the art would recognize many possible variations, alternatives, and modifications. For example, in some implementations, the various groups and subgroups of training datasets can be assigned different sampling weights than those shown in FIG. 12.

In a certain implementation, the general domain group (set of second training examples) and the target domain group (set of first training examples) are sampled using equal sampling weights (e.g., 1). In other implementations, the general domain dataset and the target domain dataset can be sampled using different sampling weights. The table depicted in FIG. 12 additionally illustrates exemplary sampling weights that can be assigned to the multiple subgroups within each group of training examples. For example, in one implementation, within the target domain data group, the training examples can further be grouped into multiple subgroups (subgroup 1 and subgroup 2). Subgroup 1 represents a first subset of first training examples that represent training examples having timestamps and subgroup 2 represents a second subset of first training examples that represent training examples with timestamps. In this implementation, the first subset of first training examples is sampled with a sampling weight of 1 and the second subset of first training examples is sampled with a sampling weight of 3.

Similarly, in one implementation, within the general domain data group, the training examples can further be grouped into multiple subgroups (subgroup 3 and subgroup 4). Subgroup 3 represents a third subset of first training examples that represent training examples having timestamps and subgroup 4 represents a fourth subset of first training examples that represent training examples with timestamps. In this implementation, the third subset of first training examples is sampled with a sampling weight of 1 and the fourth subset of first training examples is sampled with a sampling weight of 3.

At block 1108, the training data sampling subsystem generates a set of candidate training examples by sampling the first subset of first training examples, the second subset of first training examples, the third subset of second training examples, and the fourth subset of second training examples based on the sampling weights. The subsystem may utilize a variety of techniques to randomly sample a batch of training examples (i.e., a set of candidate training examples) from the various subgroups (subsets) of training examples. In one implementation, the number of training examples that are randomly sampled from each group is determined by first getting a random draw of a certain number (e.g., K trials) based on the sampling weights derived for the group. For each subset, a random sample of the corresponding size is then derived. Finally, random samples of all the subgroups are combined to form a random training batch of K examples (i.e., the set of candidate training examples). In another implementation, based on the sampling weights determined for the various groups and subgroups, a particular group or subgroup is selected to sample training examples. A certain number of samples are then sampled from the selected group to form a random training data batch of K examples. In a certain implementation, the value of K can be set to 8, 16, 32, or 64 depending on the GPU memory available for the training process.

At block 1110, the training data sampling subsystem 906 provides the set of candidate training examples to the test example evaluation subsystem which then generates an updated ASR model by fine-tuning the ASR model using the set of candidate training examples. At each training iteration, a batch of examples (i.e., a set of candidate training examples) are randomly drawn from the training dataset. A training loss and its first-order derivative is computed on the random batch of training examples. The ASR model parameters are then updated to minimize the training loss. The training iterations are continued until the training loss on the batch of samples cannot be improved further.

At block 1112, the updated ASR model is deployed to a cloud infrastructure of a cloud service provider. For instance, in certain examples, and as depicted in FIG. 2, the ASR model 210 may be deployed to a cloud service that implements an ASR system 208 in a cloud infrastructure of a cloud service provider.

### Examples Of Cloud Infrastructure

The term cloud service is generally used to refer to a service that is made available by a cloud service provider (CSP) to users (e.g., cloud service customers) on demand (e.g., via a subscription model) using systems and infrastructure (cloud infrastructure) provided by the CSP. Typically, the servers and systems that make up the CSP's infrastructure are separate from the user's own on-premise servers and systems. Users can thus avail themselves of cloud services provided by the CSP without having to purchase separate hardware and software resources for the services. Cloud services are designed to provide a subscribing user easy, scalable access to applications and computing resources without the user having to invest in procuring the infrastructure that is used for providing the services.

There are several cloud service providers that offer various types of cloud services. As discussed herein, there are various types or models of cloud services including IaaS, software as a service (SaaS), platform as a service (PaaS), and others. A user can subscribe to one or more cloud services provided by a CSP. The user can be any entity such as an individual, an organization, an enterprise, and the like. When a user subscribes to or registers for a service provided by a CSP, a tenancy or an account is created for that user. The user can then, via this account, access the subscribed-to one or more cloud resources associated with the account.

As noted above, IaaS is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

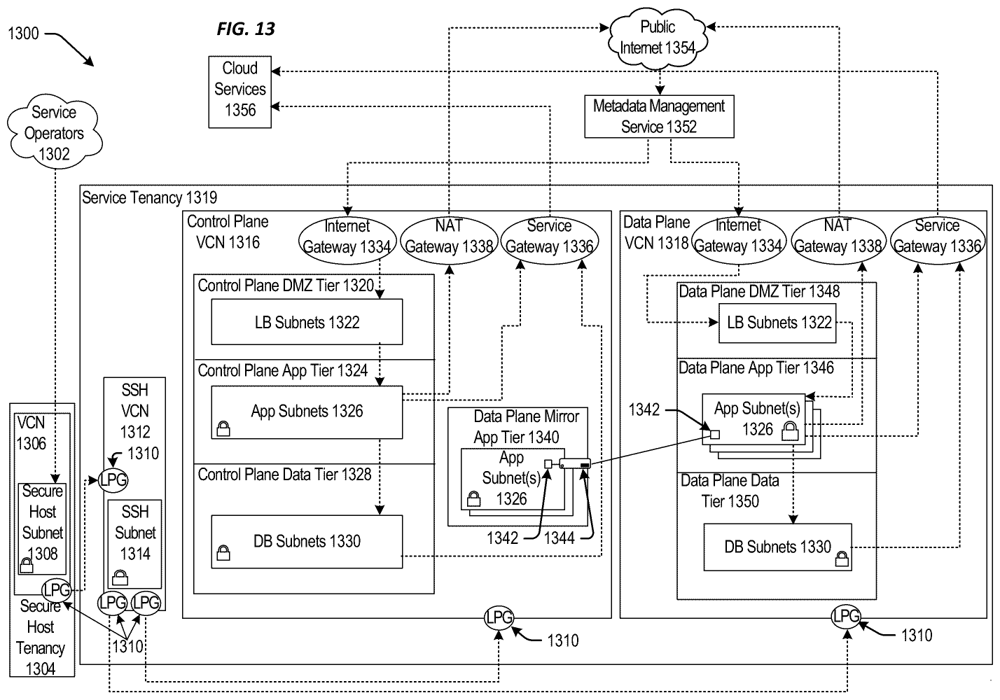

FIG. 13 is a block diagram 1300 illustrating an example pattern of an IaaS architecture, according to at least one embodiment. Service operators 1302 can be communicatively coupled to a secure host tenancy 1304 that can include a virtual cloud network (VCN) 1306 and a secure host subnet 1308. In some examples, the service operators 1302 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1306 and/or the Internet.

The VCN 1306 can include a local peering gateway (LPG) 1310 that can be communicatively coupled to a secure shell (SSH) VCN 1312 via an LPG 1310 contained in the SSH VCN 1312. The SSH VCN 1312 can include an SSH subnet 1314, and the SSH VCN 1312 can be communicatively coupled to a control plane VCN 1316 via the LPG 1310 contained in the control plane VCN 1316. Also, the SSH VCN 1312 can be communicatively coupled to a data plane VCN 1318 via an LPG 1310. The control plane VCN 1316 and the data plane VCN 1318 can be contained in a service tenancy 1319 that can be owned and/or operated by the IaaS provider.

The control plane VCN 1316 can include a control plane demilitarized zone (DMZ) tier 1320 that acts as a perimeter network (e.g., portions of a corporate network between the corporate intranet and external networks). The DMZ-based servers may have restricted responsibilities and help keep breaches contained. Additionally, the DMZ tier 1320 can include one or more load balancer (LB) subnet(s) 1322, a control plane app tier 1324 that can include app subnet(s) 1326, a control plane data tier 1328 that can include database (DB) subnet(s) 1330 (e.g., frontend DB subnet(s) and/or backend DB subnet(s)). The LB subnet(s) 1322 contained in the control plane DMZ tier 1320 can be communicatively coupled to the app subnet(s) 1326 contained in the control plane app tier 1324 and an Internet gateway 1334 that can be contained in the control plane VCN 1316, and the app subnet(s) 1326 can be communicatively coupled to the DB subnet(s) 1330 contained in the control plane data tier 1328 and a service gateway 1336 and a network address translation (NAT) gateway 1338. The control plane VCN 1316 can include the service gateway 1336 and the NAT gateway 1338.

The control plane VCN 1316 can include a data plane mirror app tier 1340 that can include app subnet(s) 1326. The app subnet(s) 1326 contained in the data plane mirror app tier 1340 can include a virtual network interface controller (VNIC) 1342 that can execute a compute instance 1344. The compute instance 1344 can communicatively couple the app subnet(s) 1326 of the data plane mirror app tier 1340 to app subnet(s) 1326 that can be contained in a data plane app tier 1346.

The data plane VCN 1318 can include the data plane app tier 1346, a data plane DMZ tier 1348, and a data plane data tier 1350. The data plane DMZ tier 1348 can include LB subnet(s) 1322 that can be communicatively coupled to the app subnet(s) 1326 of the data plane app tier 1346 and the Internet gateway 1334 of the data plane VCN 1318. The app subnet(s) 1326 can be communicatively coupled to the service gateway 1336 of the data plane VCN 1318 and the NAT gateway 1338 of the data plane VCN 1318. The data plane data tier 1350 can also include the DB subnet(s) 1330 that can be communicatively coupled to the app subnet(s) 1326 of the data plane app tier 1346.

The Internet gateway 1334 of the control plane VCN 1316 and of the data plane VCN 1318 can be communicatively coupled to a metadata management service 1352 that can be communicatively coupled to public Internet 1354. Public Internet 1354 can be communicatively coupled to the NAT gateway 1338 of the control plane VCN 1316 and of the data plane VCN 1318. The service gateway 1336 of the control plane VCN 1316 and of the data plane VCN 1318 can be communicatively coupled to cloud services 1356.

In some examples, the service gateway 1336 of the control plane VCN 1316 or of the data plane VCN 1318 can make application programming interface (API) calls to cloud services 1356 without going through public Internet 1354. The API calls to cloud services 1356 from the service gateway 1336 can be one-way: the service gateway 1336 can make API calls to cloud services 1356, and cloud services 1356 can send requested data to the service gateway 1336. But, cloud services 1356 may not initiate API calls to the service gateway 1336.

In some examples, the secure host tenancy 1304 can be directly connected to the service tenancy 1319, which may be otherwise isolated. The secure host subnet 1308 can communicate with the SSH subnet 1314 through an LPG 1310 that may enable two-way communication over an otherwise isolated system. Connecting the secure host subnet 1308 to the SSH subnet 1314 may give the secure host subnet 1308 access to other entities within the service tenancy 1319.

The control plane VCN 1316 may allow users of the service tenancy 1319 to set up or otherwise provision desired resources. Desired resources provisioned in the control plane VCN 1316 may be deployed or otherwise used in the data plane VCN 1318. In some examples, the control plane VCN 1316 can be isolated from the data plane VCN 1318, and the data plane mirror app tier 1340 of the control plane VCN 1316 can communicate with the data plane app tier 1346 of the data plane VCN 1318 via VNICs 1342 that can be contained in the data plane mirror app tier 1340 and the data plane app tier 1346.

In some examples, users of the system, or customers, can make requests, for example create, read, update, or delete (CRUD) operations, through public Internet 1354 that can communicate the requests to the metadata management service 1352. The metadata management service 1352 can communicate the request to the control plane VCN 1316 through the Internet gateway 1334. The request can be received by the LB subnet(s) 1322 contained in the control plane DMZ tier 1320. The LB subnet(s) 1322 may determine that the request is valid, and in response to this determination, the LB subnet(s) 1322 can transmit the request to app subnet(s) 1326 contained in the control plane app tier 1324. If the request is validated and requires a call to public Internet 1354, the call to public Internet 1354 may be transmitted to the NAT gateway 1338 that can make the call to public Internet 1354. Metadata that may be desired to be stored by the request can be stored in the DB subnet(s) 1330.

In some examples, the data plane mirror app tier 1340 can facilitate direct communication between the control plane VCN 1316 and the data plane VCN 1318. For example, changes, updates, or other suitable modifications to configuration may be desired to be applied to the resources contained in the data plane VCN 1318. Via a VNIC 1342, the control plane VCN 1316 can directly communicate with, and can thereby execute the changes, updates, or other suitable modifications to configuration to, resources contained in the data plane VCN 1318.

In some embodiments, the control plane VCN 1316 and the data plane VCN 1318 can be contained in the service tenancy 1319. In this case, the user, or the customer, of the system may not own or operate either the control plane VCN 1316 or the data plane VCN 1318. Instead, the IaaS provider may own or operate the control plane VCN 1316 and the data plane VCN 1318, both of which may be contained in the service tenancy 1319. This embodiment can enable isolation of networks that may prevent users or customers from interacting with other users, ‘or other customers,’ resources. Also, this embodiment may allow users or customers of the system to store databases privately without needing to rely on public Internet 1354, which may not have a desired level of threat prevention, for storage.

In other embodiments, the LB subnet(s) 1322 contained in the control plane VCN 1316 can be configured to receive a signal from the service gateway 1336. In this embodiment, the control plane VCN 1316 and the data plane VCN 1318 may be configured to be called by a customer of the IaaS provider without calling public Internet 1354. Customers of the IaaS provider may desire this embodiment since database(s) that the customers use may be controlled by the IaaS provider and may be stored on the service tenancy 1319, which may be isolated from public Internet 1354.

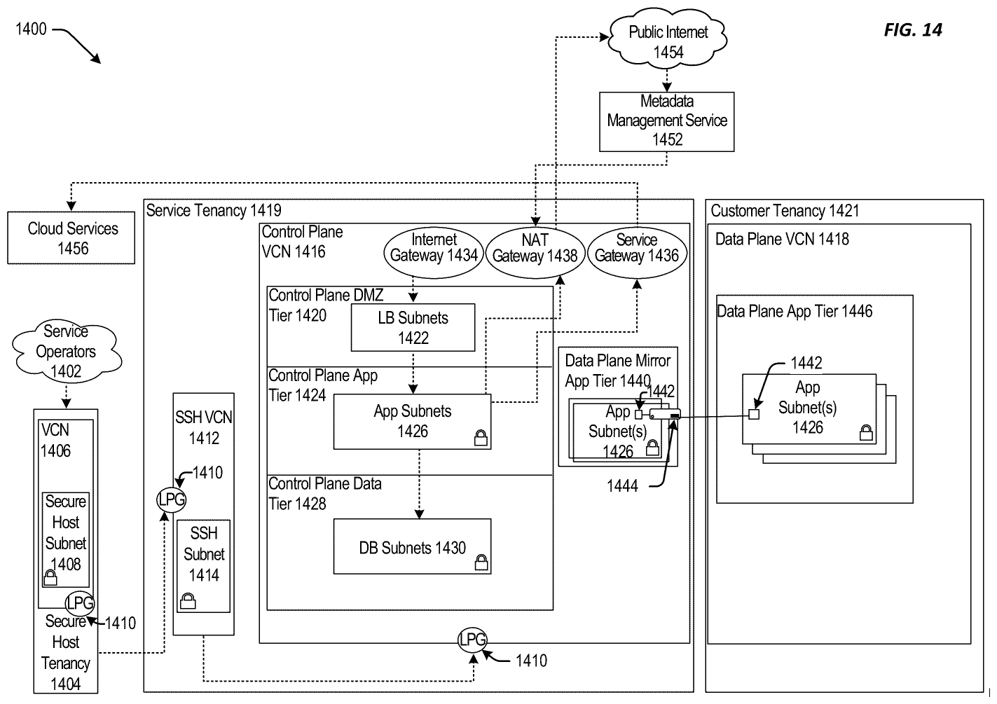

FIG. 14 is a block diagram 1400 illustrating another example pattern of an IaaS architecture, according to at least one embodiment. Service operators 1402 (e.g., service operators 1302 of FIG. 13) can be communicatively coupled to a secure host tenancy 1404 (e.g., the secure host tenancy 1304 of FIG. 13) that can include a virtual cloud network (VCN) 1406 (e.g., the VCN 1306 of FIG. 13) and a secure host subnet 1408 (e.g., the secure host subnet 1308 of FIG. 13). The VCN 1306 can include a local peering gateway (LPG) 1410 (e.g., the LPG 1310 of FIG. 13) that can be communicatively coupled to a secure shell (SSH) VCN 1412 (e.g., the SSH VCN 1312 of FIG. 13) via an LPG 1410 contained in the SSH VCN 1412. The SSH VCN 1412 can include an SSH subnet 1414 (e.g., the SSH subnet 1314 of FIG. 13), and the SSH VCN 1412 can be communicatively coupled to a control plane VCN 1416 (e.g., the control plane VCN 1316 of FIG. 13) via an LPG 1410 contained in the control plane VCN 1416. The control plane VCN 1416 can be contained in a service tenancy 1419 (e.g., the service tenancy 1319 of FIG. 13), and the data plane VCN 1418 (e.g., the data plane VCN 1318 of FIG. 13) can be contained in a customer tenancy 1421 that may be owned or operated by users, or customers, of the system.

The control plane VCN 1416 can include a control plane DMZ tier 1420 (e.g., the control plane DMZ tier 1320 of FIG. 13) that can include LB subnet(s) 1422 (e.g., LB subnet(s) 1322 of FIG. 13), a control plane app tier 1424 (e.g., the control plane app tier 1324 of FIG. 13) that can include app subnet(s) 1426 (e.g., app subnet(s) 1326 of FIG. 13), a control plane data tier 1428 (e.g., the control plane data tier 1328 of FIG. 13) that can include database (DB) subnet(s) 1430 (e.g., similar to DB subnet(s) 1330 of FIG. 13). The LB subnet(s) 1422 contained in the control plane DMZ tier 1420 can be communicatively coupled to the app subnet(s) 1426 contained in the control plane app tier 1424 and an Internet gateway 1434 (e.g., the Internet gateway 1334 of FIG. 13) that can be contained in the control plane VCN 1416, and the app subnet(s) 1426 can be communicatively coupled to the DB subnet(s) 1430 contained in the control plane data tier 1428 and a service gateway 1436 (e.g., the service gateway 1336 of FIG. 13) and a network address translation (NAT) gateway 1438 (e.g., the NAT gateway 1338 of FIG. 13). The control plane VCN 1416 can include the service gateway 1436 and the NAT gateway 1438.

The control plane VCN 1416 can include a data plane mirror app tier 1440 (e.g., the data plane mirror app tier 1340 of FIG. 13) that can include app subnet(s) 1426. The app subnet(s) 1426 contained in the data plane mirror app tier 1440 can include a virtual network interface controller (VNIC) 1442 (e.g., the VNIC of 1342) that can execute a compute instance 1444 (e.g., similar to the compute instance 1344 of FIG. 13). The compute instance 1444 can facilitate communication between the app subnet(s) 1426 of the data plane mirror app tier 1440 and the app subnet(s) 1426 that can be contained in a data plane app tier 1446 (e.g., the data plane app tier 1346 of FIG. 13) via the VNIC 1442 contained in the data plane mirror app tier 1440 and the VNIC 1442 contained in the data plane app tier 1446.

The Internet gateway 1434 contained in the control plane VCN 1416 can be communicatively coupled to a metadata management service 1452 (e.g., the metadata management service 1352 of FIG. 13) that can be communicatively coupled to public Internet 1454 (e.g., public Internet 1354 of FIG. 13). Public Internet 1454 can be communicatively coupled to the NAT gateway 1438 contained in the control plane VCN 1416. The service gateway 1436 contained in the control plane VCN 1416 can be communicatively coupled to cloud services 1456 (e.g., cloud services 1356 of FIG. 13).

In some examples, the data plane VCN 1418 can be contained in the customer tenancy 1421. In this case, the IaaS provider may provide the control plane VCN 1416 for each customer, and the IaaS provider may, for each customer, set up a unique compute instance 1444 that is contained in the service tenancy 1419. Each compute instance 1444 may allow communication between the control plane VCN 1416, contained in the service tenancy 1419, and the data plane VCN 1418 that is contained in the customer tenancy 1421. The compute instance 1444 may allow resources, that are provisioned in the control plane VCN 1416 that is contained in the service tenancy 1419, to be deployed or otherwise used in the data plane VCN 1418 that is contained in the customer tenancy 1421.

In other examples, the customer of the IaaS provider may have databases that live in the customer tenancy 1421. In this example, the control plane VCN 1416 can include the data plane mirror app tier 1440 that can include app subnet(s) 1426. The data plane mirror app tier 1440 can reside in the data plane VCN 1418, but the data plane mirror app tier 1440 may not live in the data plane VCN 1418. That is, the data plane mirror app tier 1440 may have access to the customer tenancy 1421, but the data plane mirror app tier 1440 may not exist in the data plane VCN 1418 or be owned or operated by the customer of the IaaS provider. The data plane mirror app tier 1440 may be configured to make calls to the data plane VCN 1418 but may not be configured to make calls to any entity contained in the control plane VCN 1416. The customer may desire to deploy or otherwise use resources in the data plane VCN 1418 that are provisioned in the control plane VCN 1416, and the data plane mirror app tier 1440 can facilitate the desired deployment, or other usage of resources, of the customer.

In some embodiments, the customer of the IaaS provider can apply filters to the data plane VCN 1418. In this embodiment, the customer can determine what the data plane VCN 1418 can access, and the customer may restrict access to public Internet 1454 from the data plane VCN 1418. The IaaS provider may not be able to apply filters or otherwise control access of the data plane VCN 1418 to any outside networks or databases. Applying filters and controls by the customer onto the data plane VCN 1418, contained in the customer tenancy 1421, can help isolate the data plane VCN 1418 from other customers and from public Internet 1454.

In some embodiments, cloud services 1456 can be called by the service gateway 1436 to access services that may not exist on public Internet 1454, on the control plane VCN 1416, or on the data plane VCN 1418. The connection between cloud services 1456 and the control plane VCN 1416 or the data plane VCN 1418 may not be live or continuous. Cloud services 1456 may exist on a different network owned or operated by the IaaS provider. Cloud services 1456 may be configured to receive calls from the service gateway 1436 and may be configured to not receive calls from public Internet 1454. Some cloud services 1456 may be isolated from other cloud services 1456, and the control plane VCN 1416 may be isolated from cloud services 1456 that may not be in the same region as the control plane VCN 1416. For example, the control plane VCN 1416 may be located in “Region 1,” and cloud service “Deployment 7,” may be located in Region 1 and in “Region 2.” If a call to Deployment 7 is made by the service gateway 1436 contained in the control plane VCN 1416 located in Region 1, the call may be transmitted to Deployment 7 in Region 1. In this example, the control plane VCN 1416, or Deployment 7 in Region 1, may not be communicatively coupled to, or otherwise in communication with, Deployment 7 in Region 2.

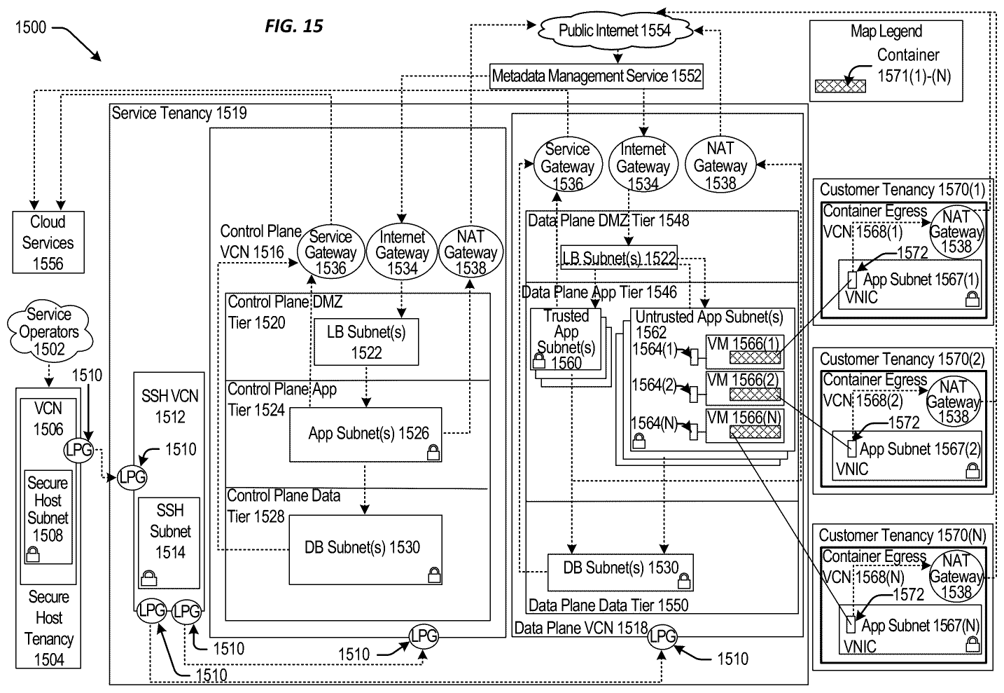

FIG. 15 is a block diagram 1500 illustrating another example pattern of an IaaS architecture, according to at least one embodiment. Service operators 1502 (e.g., service operators 1302 of FIG. 13) can be communicatively coupled to a secure host tenancy 1504 (e.g., the secure host tenancy 1304 of FIG. 13) that can include a virtual cloud network (VCN) 1506 (e.g., the VCN 1306 of FIG. 13) and a secure host subnet 1508 (e.g., the secure host subnet 1308 of FIG. 13). The VCN 1506 can include an LPG 1510 (e.g., the LPG 1310 of FIG. 13) that can be communicatively coupled to an SSH VCN 1512 (e.g., the SSH VCN 1312 of FIG. 13) via an LPG 1510 contained in the SSH VCN 1512. The SSH VCN 1512 can include an SSH subnet 1514 (e.g., the SSH subnet 1314 of FIG. 13), and the SSH VCN 1512 can be communicatively coupled to a control plane VCN 1516 (e.g., the control plane VCN 1316 of FIG. 13) via an LPG 1510 contained in the control plane VCN 1516 and to a data plane VCN 1518 (e.g., the data plane 1318 of FIG. 13) via an LPG 1510 contained in the data plane VCN 1518. The control plane VCN 1516 and the data plane VCN 1518 can be contained in a service tenancy 1519 (e.g., the service tenancy 1319 of FIG. 13).

The control plane VCN 1516 can include a control plane DMZ tier 1520 (e.g., the control plane DMZ tier 1320 of FIG. 13) that can include load balancer (LB) subnet(s) 1522 (e.g., LB subnet(s) 1322 of FIG. 13), a control plane app tier 1524 (e.g., the control plane app tier 1324 of FIG. 13) that can include app subnet(s) 1526 (e.g., similar to app subnet(s) 1326 of FIG. 13), a control plane data tier 1528 (e.g., the control plane data tier 1328 of FIG. 13) that can include DB subnet(s) 1530. The LB subnet(s) 1522 contained in the control plane DMZ tier 1520 can be communicatively coupled to the app subnet(s) 1526 contained in the control plane app tier 1524 and to an Internet gateway 1534 (e.g., the Internet gateway 1334 of FIG. 13) that can be contained in the control plane VCN 1516, and the app subnet(s) 1526 can be communicatively coupled to the DB subnet(s) 1530 contained in the control plane data tier 1528 and to a service gateway 1536 (e.g., the service gateway of FIG. 13) and a network address translation (NAT) gateway 1538 (e.g., the NAT gateway 1338 of FIG. 13). The control plane VCN 1516 can include the service gateway 1536 and the NAT gateway 1538.

The data plane VCN 1518 can include a data plane app tier 1546 (e.g., the data plane app tier 1346 of FIG. 13), a data plane DMZ tier 1548 (e.g., the data plane DMZ tier 1348 of FIG. 13), and a data plane data tier 1550 (e.g., the data plane data tier 1350 of FIG. 13). The data plane DMZ tier 1548 can include LB subnet(s) 1522 that can be communicatively coupled to trusted app subnet(s) 1560 and untrusted app subnet(s) 1562 of the data plane app tier 1546 and the Internet gateway 1534 contained in the data plane VCN 1518. The trusted app subnet(s) 1560 can be communicatively coupled to the service gateway 1536 contained in the data plane VCN 1518, the NAT gateway 1538 contained in the data plane VCN 1518, and DB subnet(s) 1530 contained in the data plane data tier 1550. The untrusted app subnet(s) 1562 can be communicatively coupled to the service gateway 1536 contained in the data plane VCN 1518 and DB subnet(s) 1530 contained in the data plane data tier 1550. The data plane data tier 1550 can include DB subnet(s) 1530 that can be communicatively coupled to the service gateway 1536 contained in the data plane VCN 1518.

The untrusted app subnet(s) 1562 can include one or more primary VNICs 1564(1)-(N) that can be communicatively coupled to tenant virtual machines (VMs) 1566(1)-(N). Each tenant VM 1566(1)-(N) can be communicatively coupled to a respective app subnet 1567(1)-(N) that can be contained in respective container egress VCNs 1568(1)-(N) that can be contained in respective customer tenancies 1570(1)-(N). Respective secondary VNICs 1572(1)-(N) can facilitate communication between the untrusted app subnet(s) 1562 contained in the data plane VCN 1518 and the app subnet contained in the container egress VCNs 1568(1)-(N). Each container egress VCNs 1568(1)-(N) can include a NAT gateway 1538 that can be communicatively coupled to public Internet 1554 (e.g., public Internet 1354 of FIG. 13).

The Internet gateway 1534 contained in the control plane VCN 1516 and contained in the data plane VCN 1518 can be communicatively coupled to a metadata management service 1552 (e.g., the metadata management system 1352 of FIG. 13) that can be communicatively coupled to public Internet 1554. Public Internet 1554 can be communicatively coupled to the NAT gateway 1538 contained in the control plane VCN 1516 and contained in the data plane VCN 1518. The service gateway 1536 contained in the control plane VCN 1516 and contained in the data plane VCN 1518 can be communicatively coupled to cloud services 1556.

In some embodiments, the data plane VCN 1518 can be integrated with customer tenancies 1570. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1546. Code to run the function may be executed in the VMs 1566(1)-(N), and the code may not be configured to run anywhere else on the data plane VCN 1518. Each VM 1566(1)-(N) may be connected to one customer tenancy 1570. Respective containers 1571(1)-(N) contained in the VMs 1566(1)-(N) may be configured to run the code. In this case, there can be a dual isolation (e.g., the containers 1571(1)-(N) running code, where the containers 1571(1)-(N) may be contained in at least the VM 1566(1)-(N) that are contained in the untrusted app subnet(s) 1562), which may help prevent incorrect or otherwise undesirable code from damaging the network of the IaaS provider or from damaging a network of a different customer. The containers 1571(1)-(N) may be communicatively coupled to the customer tenancy 1570 and may be configured to transmit or receive data from the customer tenancy 1570. The containers 1571(1)-(N) may not be configured to transmit or receive data from any other entity in the data plane VCN 1518. Upon completion of running the code, the IaaS provider may kill or otherwise dispose of the containers 1571(1)-(N).

In some embodiments, the trusted app subnet(s) 1560 may run code that may be owned or operated by the IaaS provider. In this embodiment, the trusted app subnet(s) 1560 may be communicatively coupled to the DB subnet(s) 1530 and be configured to execute CRUD operations in the DB subnet(s) 1530. The untrusted app subnet(s) 1562 may be communicatively coupled to the DB subnet(s) 1530, but in this embodiment, the untrusted app subnet(s) may be configured to execute read operations in the DB subnet(s) 1530. The containers 1571(1)-(N) that can be contained in the VM 1566(1)-(N) of each customer and that may run code from the customer may not be communicatively coupled with the DB subnet(s) 1530.

In other embodiments, the control plane VCN 1516 and the data plane VCN 1518 may not be directly communicatively coupled. In this embodiment, there may be no direct communication between the control plane VCN 1516 and the data plane VCN 1518. However, communication can occur indirectly through at least one method. An LPG 1510 may be established by the IaaS provider that can facilitate communication between the control plane VCN 1516 and the data plane VCN 1518. In another example, the control plane VCN 1516 or the data plane VCN 1518 can make a call to cloud services 1556 via the service gateway 1536. For example, a call to cloud services 1556 from the control plane VCN 1516 can include a request for a service that can communicate with the data plane VCN 1518.

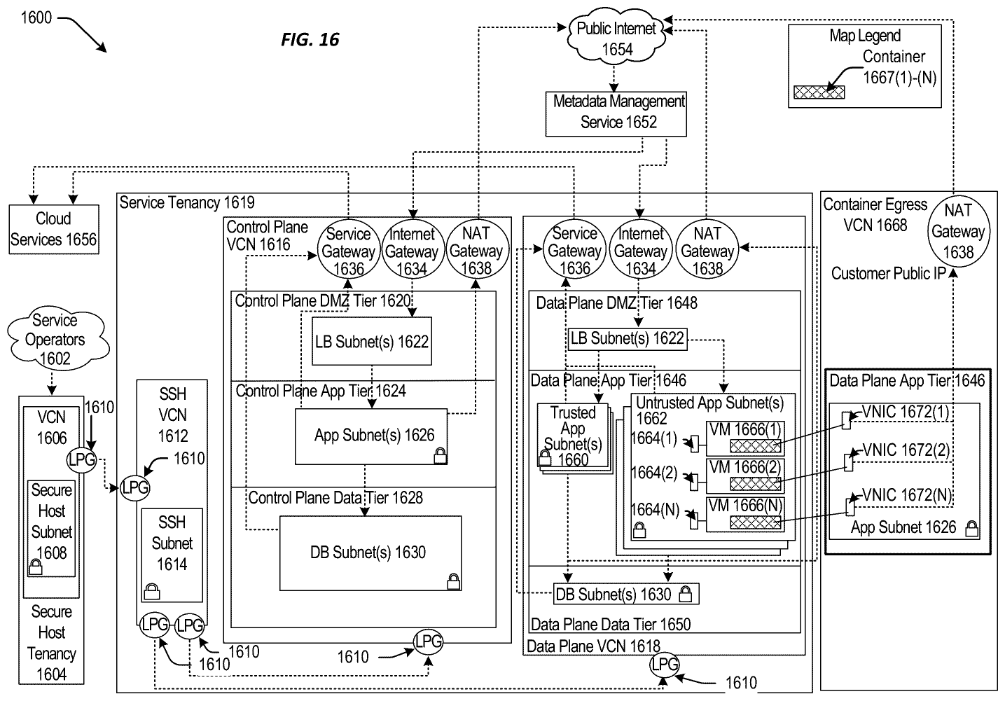

FIG. 16 is a block diagram 1600 illustrating another example pattern of an IaaS architecture, according to at least one embodiment. Service operators 1602 (e.g., service operators 1302 of FIG. 13) can be communicatively coupled to a secure host tenancy 1604 (e.g., the secure host tenancy 1304 of FIG. 13) that can include a virtual cloud network (VCN) 1606 (e.g., the VCN 1306 of FIG. 13) and a secure host subnet 1608 (e.g., the secure host subnet 1308 of FIG. 13). The VCN 1606 can include an LPG 1610 (e.g., the LPG 1310 of FIG. 13) that can be communicatively coupled to an SSH VCN 1612 (e.g., the SSH VCN 1312 of FIG. 13) via an LPG 1610 contained in the SSH VCN 1612. The SSH VCN 1612 can include an SSH subnet 1614 (e.g., the SSH subnet 1314 of FIG. 13), and the SSH VCN 1612 can be communicatively coupled to a control plane VCN 1616 (e.g., the control plane VCN 1316 of FIG. 13) via an LPG 1610 contained in the control plane VCN 1616 and to a data plane VCN 1618 (e.g., the data plane 1318 of FIG. 13) via an LPG 1610 contained in the data plane VCN 1618. The control plane VCN 1616 and the data plane VCN 1618 can be contained in a service tenancy 1619 (e.g., the service tenancy 1319 of FIG. 13).

The control plane VCN 1616 can include a control plane DMZ tier 1620 (e.g., the control plane DMZ tier 1320 of FIG. 13) that can include LB subnet(s) 1622 (e.g., LB subnet(s) 1322 of FIG. 13), a control plane app tier 1624 (e.g., the control plane app tier 1324 of FIG. 13) that can include app subnet(s) 1626 (e.g., app subnet(s) 1326 of FIG. 13), a control plane data tier 1628 (e.g., the control plane data tier 1328 of FIG. 13) that can include DB subnet(s) 1630 (e.g., DB subnet(s) 1430 of FIG. 14). The LB subnet(s) 1622 contained in the control plane DMZ tier 1620 can be communicatively coupled to the app subnet(s) 1626 contained in the control plane app tier 1624 and to an Internet gateway 1634 (e.g., the Internet gateway 1334 of FIG. 13) that can be contained in the control plane VCN 1616, and the app subnet(s) 1626 can be communicatively coupled to the DB subnet(s) 1630 contained in the control plane data tier 1628 and to a service gateway 1636 (e.g., the service gateway of FIG. 13) and a network address translation (NAT) gateway 1638 (e.g., the NAT gateway 1338 of FIG. 13). The control plane VCN 1616 can include the service gateway 1636 and the NAT gateway 1638.

The data plane VCN 1618 can include a data plane app tier 1646 (e.g., the data plane app tier 1346 of FIG. 13), a data plane DMZ tier 1648 (e.g., the data plane DMZ tier 1348 of FIG. 13), and a data plane data tier 1650 (e.g., the data plane data tier 1350 of FIG. 13). The data plane DMZ tier 1648 can include LB subnet(s) 1622 that can be communicatively coupled to trusted app subnet(s) 1660 (e.g., trusted app subnet(s) 1460 of FIG. 14) and untrusted app subnet(s) 1662 (e.g., untrusted app subnet(s) 1462 of FIG. 14) of the data plane app tier 1646 and the Internet gateway 1634 contained in the data plane VCN 1618. The trusted app subnet(s) 1660 can be communicatively coupled to the service gateway 1636 contained in the data plane VCN 1618, the NAT gateway 1638 contained in the data plane VCN 1618, and DB subnet(s) 1630 contained in the data plane data tier 1650. The untrusted app subnet(s) 1662 can be communicatively coupled to the service gateway 1636 contained in the data plane VCN 1618 and DB subnet(s) 1630 contained in the data plane data tier 1650. The data plane data tier 1650 can include DB subnet(s) 1630 that can be communicatively coupled to the service gateway 1636 contained in the data plane VCN 1618.

The untrusted app subnet(s) 1662 can include primary VNICs 1664(1)-(N) that can be communicatively coupled to tenant virtual machines (VMs) 1666(1)-(N) residing within the untrusted app subnet(s) 1662. Each tenant VM 1666(1)-(N) can run code in a respective container 1667(1)-(N), and be communicatively coupled to an app subnet 1626 that can be contained in a data plane app tier 1646 that can be contained in a container egress VCN 1668. Respective secondary VNICs 1672(1)-(N) can facilitate communication between the untrusted app subnet(s) 1662 contained in the data plane VCN 1618 and the app subnet contained in the container egress VCN 1668. The container egress VCN can include a NAT gateway 1638 that can be communicatively coupled to public Internet 1654 (e.g., public Internet 1354 of FIG. 13).

The Internet gateway 1634 contained in the control plane VCN 1616 and contained in the data plane VCN 1618 can be communicatively coupled to a metadata management service 1652 (e.g., the metadata management system 1352 of FIG. 13) that can be communicatively coupled to public Internet 1654. Public Internet 1654 can be communicatively coupled to the NAT gateway 1638 contained in the control plane VCN 1616 and contained in the data plane VCN 1618. The service gateway 1636 contained in the control plane VCN 1616 and contained in the data plane VCN 1618 can be communicatively coupled to cloud services 1656.

In some examples, the pattern illustrated by the architecture of block diagram 1600 of FIG. 16 may be considered an exception to the pattern illustrated by the architecture of block diagram 1400 of FIG. 14 and may be desirable for a customer of the IaaS provider if the IaaS provider cannot directly communicate with the customer (e.g., a disconnected region). The respective containers 1667(1)-(N) that are contained in the VMs 1666(1)-(N) for each customer can be accessed in real-time by the customer. The containers 1667(1)-(N) may be configured to make calls to respective secondary VNICs 1672(1)-(N) contained in app subnet(s) 1626 of the data plane app tier 1646 that can be contained in the container egress VCN 1668. The secondary VNICs 1672(1)-(N) can transmit the calls to the NAT gateway 1638 that may transmit the calls to public Internet 1654. In this example, the containers 1667(1)-(N) that can be accessed in real-time by the customer can be isolated from the control plane VCN 1616 and can be isolated from other entities contained in the data plane VCN 1618. The containers 1667(1)-(N) may also be isolated from resources from other customers.

In other examples, the customer can use the containers 1667(1)-(N) to call cloud services 1656. In this example, the customer may run code in the containers 1667(1)-(N) that requests a service from cloud services 1656. The containers 1667(1)-(N) can transmit this request to the secondary VNICs 1672(1)-(N) that can transmit the request to the NAT gateway that can transmit the request to public Internet 1654. Public Internet 1654 can transmit the request to LB subnet(s) 1622 contained in the control plane VCN 1616 via the Internet gateway 1634. In response to determining the request is valid, the LB subnet(s) can transmit the request to app subnet(s) 1626 that can transmit the request to cloud services 1656 via the service gateway 1636.

It should be appreciated that IaaS architectures 1300, 900, 1000, 1600 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

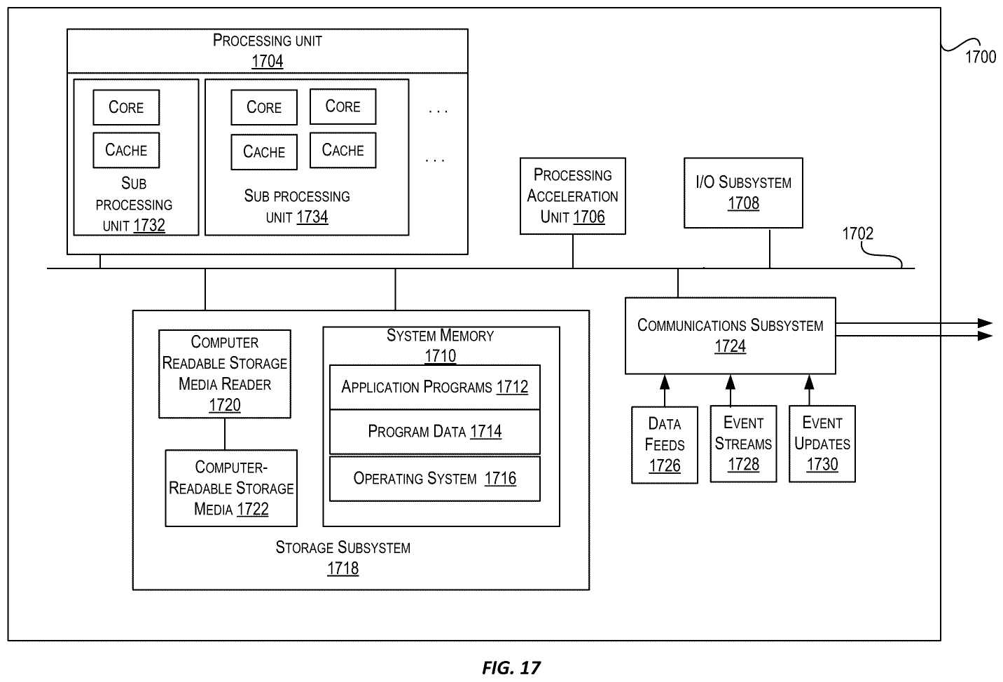

FIG. 17 illustrates an example computer system 1700, in which various embodiments may be implemented. The system 1700 may be used to implement any of the computer systems described above. As shown in the figure, computer system 1700 includes a processing unit 1704 that communicates with a number of peripheral subsystems via a bus subsystem 1702. These peripheral subsystems may include a processing acceleration unit 1706, an I/O subsystem 1708, a storage subsystem 1718 and a communications subsystem 1724. Storage subsystem 1718 includes tangible computer-readable storage media 1722 and a system memory 1710.

Bus subsystem 1702 provides a mechanism for letting the various components and subsystems of computer system 1700 communicate with each other as intended. Although bus subsystem 1702 is shown schematically as a single bus, alternative embodiments of the bus subsystem may utilize multiple buses. Bus subsystem 1702 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1704, which can be implemented as one or more integrated circuits (e.g., a conventional microprocessor or microcontroller), controls the operation of computer system 1700. One or more processors may be included in processing unit 1704. These processors may include single core or multicore processors. In certain embodiments, processing unit 1704 may be implemented as one or more independent processing units 1732 and/or 1734 with single or multicore processors included in each processing unit. In other embodiments, processing unit 1704 may also be implemented as a quad-core processing unit formed by integrating two dual-core processors into a single chip.

In various embodiments, processing unit 1704 can execute a variety of programs in response to program code and can maintain multiple concurrently executing programs or processes. At any given time, some, or all of the program code to be executed can be resident in processor(s) 1704 and/or in storage subsystem 1718. Through suitable programming, processor(s) 1704 can provide various functionalities described above. Computer system 1700 may additionally include a processing acceleration unit 1706, which can include a digital signal processor (DSP), a special-purpose processor, and/or the like.

I/O subsystem 1708 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments, and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1700 to a user or other computer. For example, user interface output devices may include, without limitation, a variety of display devices that visually convey text, graphics, and audio/video information such as monitors, printers, speakers, headphones, automotive navigation systems, plotters, voice output devices, and modems.

Computer system 1700 may comprise a storage subsystem 1718 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1704 provide the functionality described above. Storage subsystem 1718 may also provide a repository for storing data used in accordance with the present disclosure.

As depicted in the example in FIG. 17, storage subsystem 1718 can include various components including a system memory 1710, computer-readable storage media 1722, and a computer readable storage media reader 1720. System memory 1710 may store program instructions that are loadable and executable by processing unit 1704. System memory 1710 may also store data that is used during the execution of the instructions and/or data that is generated during the execution of the program instructions. Various different kinds of programs may be loaded into system memory 1710 including but not limited to client applications, Web browsers, mid-tier applications, relational database management systems (RDBMS), virtual machines, containers, etc.

System memory 1710 may also store an operating system 1716. Examples of operating system 1716 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1700 executes one or more virtual machines, the virtual machines along with their guest operating systems (GOSs) may be loaded into system memory 1710 and executed by one or more processors or cores of processing unit 1704.

System memory 1710 can come in different configurations depending upon the type of computer system 1700. For example, system memory 1710 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1710 may include a basic input/output system (BIOS) containing basic routines that help to transfer information between elements within computer system 1700, such as during start-up.

Computer-readable storage media 1722 may represent remote, local, fixed, and/or removable storage devices plus storage media for temporarily and/or more permanently containing, storing, computer-readable information for use by computer system 1700 including instructions executable by processing unit 1704 of computer system 1700.

Computer-readable storage media 1722 can include any appropriate media known or used in the art, including storage media and communication media, such as but not limited to, volatile and non-volatile, removable, and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1722 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1722 may include, but is not limited to, Zip® drives, flash memory cards, universal serial bus (USB) flash drives, secure digital (SD) cards, DVD disks, digital video tape, and the like. Computer-readable storage media 1722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1700.

Machine-readable instructions executable by one or more processors or cores of processing unit 1704 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1724 provides an interface to other computer systems and networks. Communications subsystem 1724 serves as an interface for receiving data from and transmitting data to other systems from computer system 1700. For example, communications subsystem 1724 may enable computer system 1700 to connect to one or more devices via the Internet. In some embodiments communications subsystem 1724 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.12 family standards, or other mobile communication technologies, or any combination thereof), global positioning system (GPS) receiver components, and/or other components. In some embodiments communications subsystem 1724 can provide wired network connectivity (e.g., Ethernet) in addition to or instead of a wireless interface.

In some embodiments, communications subsystem 1724 may also receive input communication in the form of structured and/or unstructured data feeds 1726, event streams 1728, event updates 1730, and the like on behalf of one or more users who may use computer system 1700.

By way of example, communications subsystem 1724 may be configured to receive data feeds 1726 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1724 may also be configured to receive data in the form of continuous data streams, which may include event streams 1728 of real-time events and/or event updates 1730, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1724 may also be configured to output the structured and/or unstructured data feeds 1726, event streams 1728, event updates 1730, and the like to one or more databases that may be in communication with one or more streaming data source computers coupled to computer system 1700.

Computer system 1700 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1700 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

As used herein, when an action is “based on” something, this means the action is based at least in part on at least a part of the something. As used herein, the terms “substantially,” “approximately” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 5, and 10 percent.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
generating a set of test examples, the set of test examples comprising subsets of test examples, each respective subset of test examples of the subsets of test examples corresponding to a particular test category of a plurality of test categories;
for each respective subset of test examples of the subsets of test examples:
using a machine learning model to convert audio samples of the respective subset of test examples to text transcripts, and
determining a word error rate for the respective subset of test examples by comparing the text transcripts to text samples corresponding to the audio samples of the respective subset of test examples, wherein the word error rate for the respective subset of test examples is included in a set of word error rates for the set of test examples;
selecting a test category of the plurality of test categories based on the word error rates for the set of test examples; and
generating a set of training examples from a selected subset of test examples of the subsets of test examples, the selected subset of test examples corresponding to the test category.

2. The computer-implemented method of claim 1, wherein generating the set of test examples comprises:
accessing a set of terms;
using a pre-trained language model to generate a set of sentences for the set of terms;
extracting a subset of sentences from the set of sentences, each sentence of the subset of sentences comprising a term in the set of terms;
processing the subset of sentences to generate a set of processed sentences, wherein processing the subset of sentences comprises normalizing text in the subset of sentences and phonetically transcribing the text in the subset of sentences;
using a text-to-speech model to generate a plurality of audio samples for each respective processed sentence of the set of processed sentences; and
forming the set of test examples based on the plurality of audio samples and the subset of sentences.

3. The computer-implemented method of claim 1, wherein generating the set of test examples comprises:
accessing a template comprising a set of named entity classes;
accessing lists of values for the set of named entity classes; and
forming the set of test examples by:
(i) selecting a respective named entity class of the set of named entity classes;
(ii) selecting a value from a list of values of the lists of values, the list of values corresponding to the respective named entity class,
(iii) populating a portion of the template corresponding to the respective named entity class,
(iv) repeating steps (i)-(iii) for each respective named entity class of the set of named entity classes, and
(v) repeating steps (i)-(iv) a predetermined number of times.

4. The computer-implemented method of claim 1, wherein the word error rate for the respective subset of test examples is determined by comparing a text transcript for a respective test example of the respective subset of test examples to a text sample corresponding to an audio sample for the respective test example, the text sample being included in the text samples and the audio sample being included in the audio samples.

5. The computer-implemented method of claim 1, wherein selecting the test category of the plurality of test categories comprises identifying a candidate word error rate in the set of word error rates that is the greatest among word error rates in the set of word error rates, identifying a candidate subset of test examples of the set of test examples that is associated with the candidate word error rate, and identifying a candidate test category that is associated with the candidate subset of test examples, the candidate test category being included in the plurality of test categories.

6. The computer-implemented method of claim 1, wherein the set of training examples are generated from the selected subset of test examples by applying a data augmentation technique to the selected subset of test examples, wherein a total speech time that is associated with the set of training examples is greater than a total speech time associated with the selected subset of test examples.

7. The computer-implemented method of claim 1, wherein the set of training examples is a set of first training examples, wherein the set of first training examples comprises a first subset of first training examples and a second subset of first training examples, and the method further comprising:
accessing a set of second training examples, the set of second training examples comprising a third subset of second training examples and a fourth subset of second training examples;
assigning sampling weights to the first subset of first training examples, the second subset of first training examples, the third subset of second training examples, and the fourth subset of second training examples;
sampling a set of candidate training examples from the first subset of first training examples, the second subset of first training examples, the third subset of second training examples, and the fourth subset of second training examples based on the sampling weights;
generating an updated machine learning model by fine-tuning the machine learning model using the set of candidate training examples; and
deploying the updated machine learning model to a cloud infrastructure of a cloud service provider.

8. The computer-implemented method of claim 7, further comprising:
prior to assigning sampling weights to the first subset of first training examples, the second subset of first training examples, the third subset of second training examples, and the fourth subset of second training examples, using a hyperparameter tuning process to identify the sampling weights.

9. The computer-implemented method of claim 7, further comprising:
accessing an audio recording;
providing the audio recording to the updated machine learning model;
using the updated machine learning model to convert the audio recording to a transcript for the audio recording; and
storing the transcript in a storage medium of the cloud infrastructure.

10. A system comprising:
one or more processing systems; and
one or more computer-readable media storing instructions which, when executed by the one or more processing systems, cause the system to perform operations comprising:
generating a set of test examples, the set of test examples comprising subsets of test examples, each respective subset of test examples of the subsets of test examples corresponding to a particular test category of a plurality of test categories;
for each respective subset of test examples of the subsets of test examples:
using a machine learning model to convert audio samples of the respective subset of test examples to text transcripts, and
determining a word error rate for the respective subset of test examples by comparing the text transcripts to text samples corresponding to the audio samples of the respective subset of test examples, wherein the word error rate for the respective subset of test examples is included in a set of word error rates for the set of test examples;
selecting a test category of the plurality of test categories based on the word error rates for the set of test examples; and
generating a set of training examples from a selected subset of test examples of the subsets of test examples, the selected subset of test examples corresponding to the test category.

11. The system of claim 10, wherein generating the set of test examples comprises:
accessing a set of terms;
using a pre-trained language model to generate a set of sentences for the set of terms;
extracting a subset of sentences from the set of terms, each sentence of the subset of sentences comprising a term in the set of terms;
processing the subset of sentences to generate a set of processed sentences, wherein processing the subset of sentences comprises normalizing text in the subset of sentences and phonetically transcribing the text in the subset of sentences;
using a text-to-speech model to generate a plurality of audio samples for each respective processed sentence of the set of processed sentences; and
forming the set of test examples based on the plurality of audio samples and the subset of sentences.

12. The system of claim 10, wherein generating the set of test examples comprises:
accessing a template comprising a set of named entity classes;
accessing lists of values for the set of named entity classes; and
forming the set of test examples by:
(i) selecting a respective named entity class of the set of named entity classes;
(ii) selecting a value from a list of values of the lists of values, the list of values corresponding to the respective named entity class,
(iii) populating a portion of the template corresponding to the respective named entity class,
(iv) repeating steps (i)-(iii) for each respective named entity class of the set of named entity classes, and
(v) repeating steps (i)-(iv) a predetermined number of times.

13. The system of claim 10, wherein the word error rate for the respective subset of test examples is determined by comparing a text transcript for a respective test example of the respective subset of test examples to a text sample corresponding to an audio sample for the respective test example, the text sample being included in the text samples and the audio sample being included in the audio samples.

14. The system of claim 10, wherein selecting the test category of the plurality of test categories comprises identifying a candidate word error rate in the set of word error rates that is the greatest among word error rates in the set of word error rates, identifying a candidate subset of test examples of the set of test examples that is associated with the candidate word error rate, and identifying a candidate test category that is associated with the candidate subset of test examples, the candidate test category being included in the plurality of test categories.

15. The system of claim 10, wherein the set of training examples are generated from the selected subset of test examples by applying a data augmentation technique to the selected subset of test examples, wherein a total speech time that is associated with the set of training examples is greater than a total speech time associated with the selected subset of test examples.

16. The system of claim 10, wherein the set of training examples is a set of first training examples, wherein the set of first training examples comprises a first subset of first training examples and a second subset of first training examples, and the operations further comprising:
accessing a set of second training examples, the set of second training examples comprising a third subset of second training examples and a fourth subset of second training examples;
assigning sampling weights to the first subset of first training examples, the second subset of first training examples, the third subset of second training examples, and the fourth subset of second training examples;
sampling a set of candidate training examples from the first subset of first training examples, the second subset of first training examples, the third subset of second training examples, and the fourth subset of second training examples based on the sampling weights;
generating an updated machine learning model by fine-tuning the machine learning model using the set of candidate training examples; and
deploying the updated machine learning model to a cloud infrastructure of a cloud service provider.

17. The system of claim 16, the operations further comprising:
prior to assigning sampling weights to the first subset of first training examples, the second subset of first training examples, the third subset of second training examples, and the fourth subset of second training examples, using a hyperparameter tuning process to identify the sampling weights.

18. The system of claim 16, the operations further comprising:
accessing an audio recording;
providing the audio recording to the updated machine learning model;
using the updated machine learning model to convert the audio recording to a transcript for the audio recording; and
storing the transcript in a storage medium of the cloud infrastructure.

19. One or more non-transitory computer-readable media storing instructions which, when executed by one or more processors, cause a system to perform operations comprising:
generating a set of test examples, the set of test examples comprising subsets of test examples, each respective subset of test examples of the subsets of test examples corresponding to a particular test category of a plurality of test categories;
for each respective subset of test examples of the subsets of test examples:
using a machine learning model to convert audio samples of the respective subset of test examples to text transcripts, and
determining a word error rate for the respective subset of test examples by comparing the text transcripts to text samples corresponding to the audio samples of the respective subset of test examples, wherein the word error rate for the respective subset of test examples is included in a set of word error rates for the set of test examples;
selecting a test category of the plurality of test categories based on the word error rates for the set of test examples;
generating a set of first training examples from a selected subset of test examples of the subsets of test examples, the selected subset of test examples corresponding to the test category, wherein the set of first training examples comprises a first subset of first training examples and a second subset of first training examples;
accessing a set of second training examples, the set of second training examples comprising a third subset of second training examples and a fourth subset of second training examples;
assigning sampling weights to the first subset of first training examples, the second subset of first training examples, the third subset of second training examples, and the fourth subset of second training examples;
sampling a set of candidate training examples from the first subset of first training examples, the second subset of first training examples, the third subset of second training examples, and the fourth subset of second training examples based on the sampling weights;
generating an updated machine learning model by fine-tuning the machine learning model using the set of candidate training examples; and
deploying the updated machine learning model to a cloud infrastructure of a cloud service provider.

20. The one or more non-transitory computer-readable media of claim 19, the operations further comprising:
accessing an audio recording;
providing the audio recording to the updated machine learning model;
using the updated machine learning model to convert the audio recording to a transcript for the audio recording; and
storing the transcript in a storage medium of the cloud infrastructure.
